(19) United States
(12) Patent Application Publication
(10) Pub. No.: US 2016/0125470 A1
(43) Pub. Date: May 5, 2016

(54) Method for Marketing and Promotion Using a General Text-To-Speech Voice System as Ancillary Merchandise

(71) Applicant: John Karl Myers, North Hills, CA (US)

(72) Inventor: John Karl Myers, North Hills, CA (US)

(21) Appl. No.: 14/530,757

(22) Filed: Nov. 2, 2014

(51) Int. Cl. G06Q 30/02

(52) U.S. Cl. CPC G06Q 30/0269

(57) ABSTRACT

A method for marketing and promotion by marketing & purveying a general Text-To-Speech (TTS) voice system, which uses the voice of a famous person, as ancillary merchandise. First, procure a general-TTS voice system that uses the voice of a famous person known for something. In one embodiment, this system is a product that itself is marketed to customers; in another embodiment, the TTS voice system is incorporated into an other product to form a composite product, then the composite product is marketed to customers. Second, market & purvey the TTS to fans and customers as ancillary merchandise featuring the famous personality. This thus enables a wide range of venues, such as concerts, movie launches, charity auctions, sports events, etc. In one aspect, the act of marketing & purveying the ancillary TTS system thus creates or augments an overall marketing/sales promotion campaign. In another aspect, since a general TTS system is useful, it will likely be received favorably and used indefinitely. So the customer will continue to hear the famous personality's voice during everyday usage, and thus receive potentially hundreds of personal, favorable, high-quality marketing impressions over years of enjoyment. Costly marketing is thus reversed into a profit center when a TTS is marketed as ancillary merchandise using this method.

### BACKGROUND

Marketing is typically extremely expensive. One Super Bowl commercial can cost a company millions of dollars—and it's only seen once, for one impression, for thirty seconds. But, what if there were a way to make money from marketing? Instead of costing millions, what if there were a way to make millions of dollars—while generating hundreds of high-quality marketing impressions per customer?

Previous ancillary merchandise marketing efforts, such as promotions using jackets, mints, and hand towels with Elvis Presley on them, have never focused on a general TTS system that can read arbitrary emails. And previously electronic companies, such as Apple, Google, and Radio Shack, which have tried to market their products using a Text-To-Speech (TTS) system, have for decades based it on the strength of an unknown, generic voice chosen for clarity. Additional generic voices are often given away, or sold for next to nothing, since they are widely perceived as having little or no value.

This patent describes a method for marketing and promotion which can provide profitable results. Unlike previous ancillary merchandise such as a branded napkin, which is used once and then thrown away, a famous-personality TTS voice on e.g. a personal smart-phone can be used every day for years. And unlike a generic TTS voice, a favorite famous voice provides value and pleasure on its own, thus making the task of marketing and promotion more straightforward. The result is valuable marketing that can pay for itself.

### DISCUSSION OF THE PRIOR ART

1. Entities Requiring Marketing and Promotion

There are a number of different types of entities who want to keep their personalities at top-of-mind. Studios and producers want to launch new movies, plays, musicals, concerts, conferences, or gatherings. Singers, reality stars, and comedians want to promote themselves. Charities and foundations want to promote their fund-raising efforts, and raise awareness, by using celebrities. Bloggers and YouTube stars want to promote themselves and their channels. And, in the future, next-generation talking car/robot/appliance manufacturers will want to promote their brand, and their products and services, by associating with celebrities. In all of these cases, promotion hinges around a special, famous person. However, none of these entities are presently using general TTS systems for promotion.

2. Prior Art in Ancillary Merchandise

The aim of ancillary merchandise is to sell a product or service to current or new fans, with the goals of both increasing the number, length, and quality of “marketing impressions” (momentary experiences of the brand or personality), and also making a profit when possible.

In the past, the archetypal ancillary merchandise, or “merch”, sold at concerts has been the T-shirt. This typically has the entity's name or logo on it. The fan derives enjoyment and receives mutually-beneficial impressions from it each time it is worn, which could be perhaps once a week for a few months—only a couple of times.

Other typical ancillary merchandise includes branded hoodies, the wall poster, hats, bracelets and other accessories, the mug, fan magazines, figurines or toys, and other lines of clothing.

Pee Wee Herman, and other celebrities such as Michael Jackson, Flip Wilson, and “Dr. J” Julius Erving, licensed talking plush dolls with a pull-string on the back that would say around 10 canned phrases. The dolls were of extremely limited use, and could not be used for real-life general applications, such as giving driving directions, reading email, etc.

But all of these are physical items. They have the disadvantages that they require inventorying, storage, trucking, and large sales space. At a concert or special event, customers may have to wait in line to purchase physical goods, leading to frustration, wasted time, and potential changed-mind drop-outs. Either the number of units trucked in to the event is too many, in which case the seller has to eat the overrun—destroying the extra units or trucking them back into inventory for next time. Or, the number of units is too few to meet demand, in which case the seller is inefficiently leaving money on the table. Physical inventory also requires pre-manufacturing. This ties up large amounts of capital in risky inventory for an indeterminate amount of time, without any guarantees that it will generate a profit and not get written off as surplus.

Contrast this against a branded TTS computer voice system for the fan's smart phone or favorite device. A customer is going to be using his or her smart phone multiple times every single day, for perhaps the next two years. When the smart phone speaks with the voice of the special personality, the fan gets to enjoy a personal impression experience each time the phone is used. This gives higher quantities of branding impressions for promotion. And since a smart phone, like glasses or a wallet, is highly personal and treated almost as an extension of the body, this also gives higher quality impressions.

Since the branded TTS computer voice system can be embodied as a digital download, there are no inventory requirements, no physical storage needs, no shipping needs, no need to overshoot or undershoot the demand. There is no need for a bulky storefront area—the people in charge can simply announce that the TTS computer voice ancillary merchandise product is available for sale online, and fans can each individually go buy and download the product right then. There is no waiting in line.

Commercial TTS systems have been around for at least 35 years, and yet no singers are taking advantage of them for ancillary merchandise products. When Disney rolls out a new movie, there is a department that lines up new T-shirts, new mugs, new music videos, and new video games. But there is currently no department that asks Angelina Jolie to sit for a new ancillary Text-To-Speech voice.

3. Prior Art in Digital Ancillary Merchandise

Recently other kinds of branded products have been offered as apps for smart phones.

Madonna, singer Reba and others have apps that are basically a rework of each of their websites, with pictures and concert listings.

Lady Gaga has an app that plays music, and also functions as an artistic experience.

Bjork has a Biophilia app that lets you compose music.

Mariah Carey has a “Carey-oke” app that allows you to sing her songs and get graded on them.

T-Pain has a branded “autotune” voice changer app that digitally filters your own voice to make you sound like a rave club singer.

William Shatner has a Shatoetry app that lets you create random poems from a small, restricted set of pre-recorded words, like poems made from one-word refrigerator magnets. This is basically an extension of the pull-string talking doll in the digital age. Building a desired custom sentence is laborious, and takes much time. Then you press a button, and it speaks each of the words, with pauses in the middle. Although an amusing toy, this app is useless for any real-world application. You can't have it read your email, or your twitter feed. It cannot pronounce words that it has never seen before, that are not in its limited vocabulary. It is not useful for general applications. It is hard to imagine it being used every day for a month, let alone for a couple years. A branded general TTS voice system. on the other hand, offers substantially higher utility, better marketing and promotion, and a higher and longer number of impressions, precisely because it can be employed in general everyday usage. And, after its initial set-up has been locked in, there is zero interaction to make it say the next sentence—no user interface at all is required for everyday speaking, which renders its usage hands-free and completely transparent. Although the makers of Shatoetry, like any software production house, could have made a general TTS system, this was evidently not obvious to them and they did not.

There have been a number of efforts in replaying canned phrases for celebrity voice navigation for the particular application of GPS-driven driving directions. Sygic offers the voices of Homer Simpson, his boss Mr. Burns, and Snoop Dogg. Waze supports Kevin Hart and Terry Crews. Locutio also supports Darth Vader, Bugs Bunny, and Daffy Duck. All of these are also basically sophisticated versions of the pull-string doll—they play back pre-recorded canned phrases at appropriate times. They cannot be used for reading e-mail or other general tasks. As a result, the interaction for GPS systems is limited to only the times that the customer wants to get driving directions. As well, since there is only a short, finite number of pre-recorded phrases, after a while listening to the same phrases being repeated from one of these systems grows tiresome. These features again severely limit the usefulness of the impressions. And though many general TTS systems have been in use for decades, it was not obvious to the makers of these GPS systems to create a viable ancillary-merchandise product based on general TTS voices.

Although general TTS computer speech generation has been around for at least 35 years, no known celebrity has asked for and pushed through a commercial product of his or her voice, rendered as a general Text-To-Speech system ancillary merchandise product.

4. Prior Art in Using Generic TTS Voices for Marketing and Promotion

Talking systems have been marketed for over 35 years, starting e.g. with the TI Speak & Spell product of 1978. A clear-voiced, unknown, generic professional speaker was recorded and used to generate the phoneme data for the LPC electronic voice parameters. Chrysler sold cars with the EVA Electronic Voice Alert built in, starting from 1983. Again, generic clear-voiced speakers were used to create voices in English, French, and Spanish. Some of the first general TTS systems were marketed under the Votrax brand by The Federal Screw Works circa 1980, including as the TRS-80 Speech Module for the Radio Shack computer. These again used a clear-voiced generic speaker as source.

Since that time, general TTS has been in continual research and development around the world, and the obvious course of action has always been to select the human speaker to be recorded primarily on the basis of having a clear voice, as well as on the basis of native language to be covered. Usually, an unknown radio or television announcer is brought in. The second obvious choice is for the researcher or producer to acquire voices from him or herself, plus immediate colleagues. For example, Prof. Bruce Hayes of UCLA provided the voice recordings for Apple's “Bruce” voice.

Most people cannot even name the voice actress who provided the American English voice of Siri.

Apple Inc., at times the most valuable company in the world, is widely acknowledged as being one of the most original, top creative companies on the planet. Apple unofficially introduced a general TTS engine MacinTalk in 1984, included with the Macintosh computer, and has been officially supporting included versions of MacinTalk since at least System 6.0.7 in 1990. Most of these voices used pure electronic-music synthesis techniques, such as frequency modulation, to achieve novelty “robot”, “cello”, or “bubbling” effects. At the time, Apple included these voices as free with its operating system. They did not have extra value.

Apple's “Victoria” voice dates to at least 1997 and was re-used in Apple's Mac OS X starting c. 2001. Advanced diphone TTS voices such as “Vicki” (2003) and “Alex” (2007) were included free in later Mac OS X versions. Apple introduced its first iPhone smart-phone in 2007, seven years ago. Apple's talking Siri product on the iPhone 4S was launched in 2011; the voices themselves were again free. Apple used Siri to market its product, but Siri was known only for being a TTS voice in an iPhone (a primary product). It was not obvious to Apple to market a TTS voice based on someone who is already famous (an ancillary product). Instead, the first deciding factor for marketing the TTS product and for picking the voice speaker was native language, as Apple supported at least 11 major languages. The second deciding factor was clarity. As has been the industry standard for decades, it was obvious to Apple and its licensors to hire relatively unknown professional voiceover artists to record for creating its products. These included Susan Bennett as the American English voice of Siri, recorded in 2005; Karen Jacobsen as the Australian English voice of “Karen”; and announcer Jon Briggs as the British English voice of “Daniel”. None of these computer voices have any intrinsic value or marketability apart from that of the actual TTS system itself.

Apple has not marketed these voices separately. There is no stand-alone “Daniel” or “Karen” TTS system product. Although Apple is using the primary merchandise of Siri to help market its products, and is using the ancillary songs and images of U2 and Bono to help launch its new iPhone 6, it has not been obvious to Apple to market the iPhone 6 by procuring and using the ancillary voice of Bono as its talking TTS.

Apple's iTunes store has categories for all the obvious products, including Songs; Albums; TV Shows; Movies; Books; Free Apps; Paid Apps; and Music Videos. There is no separate major category for Computer Voice Fonts, as it's hard to imagine that people might want to buy these separately.

Amazon sells practically every product imaginable. Like Apple, it also has separate “stores” for both music and smartphone apps, along with 36 other major categories. Also like Apple, there is no other special category for computer voices.

Amazon bought leading TTS maker IVONA. Amazon/IVONA again compete based on the number of languages covered (23), the clarity and smoothness of the voices, and the number of voices offered (51), all as of 2014. They do not market based on celebrity voices. IVONA has been making voices since around 2005.

In January 2014, Google was the 4^{th}-largest public company by market capitalization in America. From automobiles that drive themselves, to Google Glass, to the Android operating system, the 50,000 people working for Google are widely acknowledged as being some of the most brilliant and creative in the world. Android Inc. was started in 2003 and bought by Google in 2005; the first public Android OS smartphone was sold in 2008. The Android OS's “Pico” TextToSpeech capability has been included free and standard with the operating system since at least the API 1.6 Level 4 “Donut” version of 2009. Google voices for different languages are given away free in various “SpeechSynthesis” download packages. Google's most recent 2014 television commercial, “Ask the Google App”, stresses the strength of its question-answering system with a clear, generic voice. For at least five years of smart phones and constant improvements, Google is still competing based on the clarity of its voices and the number of languages supported, and not on who the voice is. Thus Google has also failed to provide a stand-alone premium TTS voice that is commercially successful, nor is using such an ancillary voice in its marketing and promotion.

Nuance is the industry leading custom TTS System provider. With 40 languages and 70 voices, it again markets and competes based on the number of languages, the number of voices available, and the clearness and smoothness of the voice. Nuance first started in 1994, merged with voice company ScanSoft in 2005, and bought what used to be the industry-leading speech company of Lernout & Hauspie in 2001. None of the Nuance groups market based on celebrity personality voices.

Notice that the obvious “clear speaker” criterion in current use by the industry goes directly opposite to the approach presented here. Sean Connery slurs his “S”s. Sylvester Stallone mumbles. Arnold Schwarzenegger has an extremely strong foreign accent. None of them speak clear, broadcaster-quality, Midwest Standard American English. These well-known people would be some of the last chosen for the voice of a present-generation “generic” TTS system.

Generic voices also offer little or no emotional attachment. Contrast this against a favorite celebrity voice selected by the customer. The customer delights in hearing the special voice of the famous person speaking in his or her ear every day. Just like listening to a favorite song from a favorite voice artist, it offers identity and positive self-affirmation. This factor can offer surprisingly good emotional results and “stickiness” loyalty, not found in other ancillary merchandise nor other, generic TTS voices.

In summary, although smart phones have been ubiquitous for years, the voices used in their general text-to-speech systems are considered to obviously have largely no intrinsic marketing value by themselves. As of 2014 there is no popular consumer market in premium TTS voice fonts. Hundreds of millions of consumers buy song recordings each year so they can enjoy listening to the voices of their favorite singers, but there is no market and no products where they can buy the voice fonts of their favorite personalities to enjoy on their devices. Although commercial TTS systems have been sold for over 35 years, there is no marketing and promotion going on based on using celebrity TTS systems as ancillary merchandise.

### Advantages

Accordingly, several advantages of one or more aspects are as follows:

Selling a TTS system to customer fans as part of a marketing & promotion campaign can turn costly marketing into a profit center for this part of the campaign.

Since an ancillary TTS system can be sold as a digital download, there is no physical inventory required. This negates the risks of overruns, underruns, transportation, pre-manufacturing, and booth space. An announcement can simply be made from the stage, or from a Jumbotron, and fans can purchase and download the merchandise themselves, thus saving time and trouble.

The marketing of an ancillary TTS system itself immediately gives an attractive, newsworthy event. This can be publicized just by itself, or can be the cornerstone around which an entire larger overall marketing & promotion campaign is woven.

Each time a customer listens to the voice of the famous person, it serves to remind the customer, and counts as another marketing impression.

A TTS system can read arbitrary text to the customer, so the customer will not grow weary of hearing the same canned expressions found in pre-recorded systems.

Customers enjoy listening to the celebrity TTS product. This gives pleasure to the customers.

A commuter can listen to the voice reading email or giving reports in the car every day, hands-free.

Fans will derive enjoyment and humor from listening to the famous person's voice read various words.

A fan can have an emotional attachment to the voice of a favorite personality. This can support the customer growing fond of hearing the voice. It also makes the TTS system fun and desirable.

A further advantage is customers can listen to a favorite voice for a longer time without getting tired.

A TTS System package/product has the option of being embodied purely as software, or as a hardware module, e.g. a chip, card, cartridge, USB dongle, etc. This gives flexibility to marketing & purveying.

A TTS System can run on a large variety of target hardware devices. This makes it valuable to the customer in a large variety of possibilities.

A fan will likely listen to the promotional voice quite often, every time it's necessary to listen to something being read out loud on the hardware device, which can be several times a day. This gives a quantitative advantage in marketing and promotion to the product over simple voice toys.

A fan will listen to the promotional voice over a very long period of time, perhaps several years. It has the potential for becoming a major part of his or her life. This results in multiple, high-quality impressions over the long term.

An ancillary TTS voice also has the benefit of marketing & promoting itself. When the friends of the customer hear the famous voice coming from the hardware device, they may want to get one too.

Since the voice is that of a well-known person, the method produces a product that is easier to make a yes-or-no decision on. Customers do not have to spend time interviewing the voice product as much. They already know whether they like the voice or not. An ancillary voice is one of the few products that practically sells itself. This makes the marketing faster, easier, and more powerful than before.

An ancillary TTS voice may be used to help launch a new movie, opera, musical, play, or charity event. It can even help launch a new celebrity who is in the process of becoming famous.

Bundling or embedding an ancillary voice in with or into an other product, such as a talking automobile, coffee maker, drone, cloud service, cloud-based movie subscription service, personal robot, etc., can help market & promote the resulting combined product substantially.

Many objects in the upcoming future “Internet of Things” will benefit from the ability to speak. Using a branded celebrity voice for these objects allows the voice to be incorporated in a wide variety of other products, and thus marketed & purveyed as a composite product of talking object plus voice.

A branded voice may be bundled with, and used to sell, practically any other vaguely related product.

When done properly, because a general TTS system should include the use and generation of most important phonemes or diphones, it may then be possible to create a TTS system that presents the famous person speaking fluently in a foreign language that he or she does not normally speak in. For example, a movie star's voice whose native tongue is English may be made to speak Spanish or Japanese with the right TTS engine. This can substantially enlarge the market of potential customers over previous-art cases of simply playing back recordings of the star saying canned utterances.

Since the customers enjoy the voice, they are attracted to it, and feel that the voice product is valuable. This allows selling a branded voice product at a higher fair price than an unknown, generic voice.

A high-tech celebrity computer voice may in fact have high perceived value similar to a concert ticket. Celebrity TTS voices have the potential of selling as auxiliary merchandise at a higher fair price point than other common tchotchkes such as coasters or bracelets. And, they have the potential of selling at a much higher fair price point than generic TTS voices, many of which are currently considered to have little or no value and are given away for free.

Declaring a TTS to be valuable ancillary merchandise transforms it, and, compared to a regular generic TTS, opens up a much wider range of venues from which it can be marketed and purveyed.

Other advantages of one or more aspects will be apparent from a consideration of the drawings and ensuing description.

### SUMMARY

A method for marketing and promotion using a general Text-To-Speech (TTS) voice system, which uses the voice of a famous person, as ancillary merchandise. An entity or group of entities wishes to create marketing and promotion. The entity or group procures a general-TTS voice system that uses the voice of a famous person. In one embodiment, the TTS voice system is a product that itself is marketed to customers; in another embodiment, the TTS voice system is a product or package that is incorporated into an other product to form a composite product, then the composite product is marketed to customers. The TTS voice system is declared to be ancillary merchandise. The entity or group markets and purveys, or sells, or causes or allows to sell, or gives out for free, or rents/leases, or licenses, or releases as a subscription, or embeds, or bundles, or distributes, the general TTS voice system or other product incorporating it to fans and customers, as ancillary merchandise featuring the famous person. The customer then may use the TTS voice system of the famous personality, running on a hardware device, on an everyday basis. Marketing and promotion may thus be created through at least two aspects of the method or system. First, the act of selling, giving, or bundling etc. creates or augments publicity. Second, each time the customer uses the TTS voice system on his or her hardware device, the customer will hear the voice of the famous person and thus receive a marketing impression. Marketing such a TTS as ancillary merchandise also opens up a large range of potential venues (channels) through which to market. In addition, using an ancillary TTS for marketing and promotion in various embodiments supports a range of other products that the TTS can be combined with. In this way, the entity or group obtains marketing and publicity.

### DRAWINGS

### Figures

In the drawings, a box with text indicates an action step, while an oval indicates an entity or thing. And parts with the same numbering but different letter suffixes represent alternative embodiments that are variously substituted in for their corresponding part without a letter suffix, all other things being equivalent.

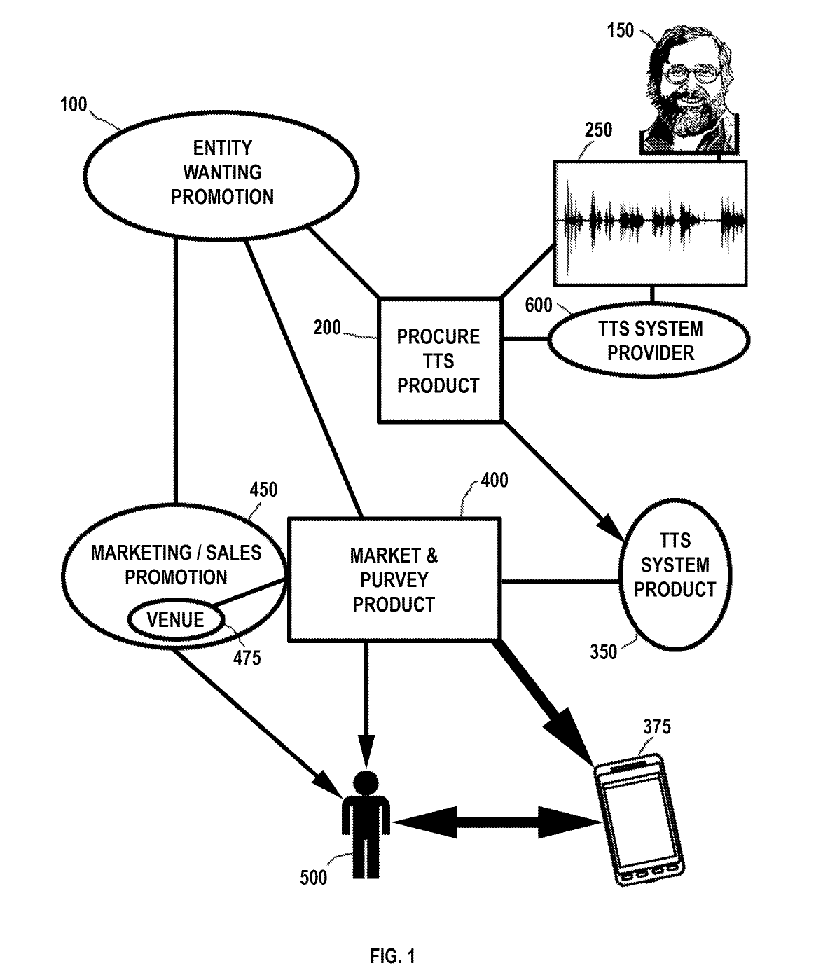

FIG. 1 shows an overall view of a first embodiment of the method, marketing & selling a TTS System Product 350 directly.

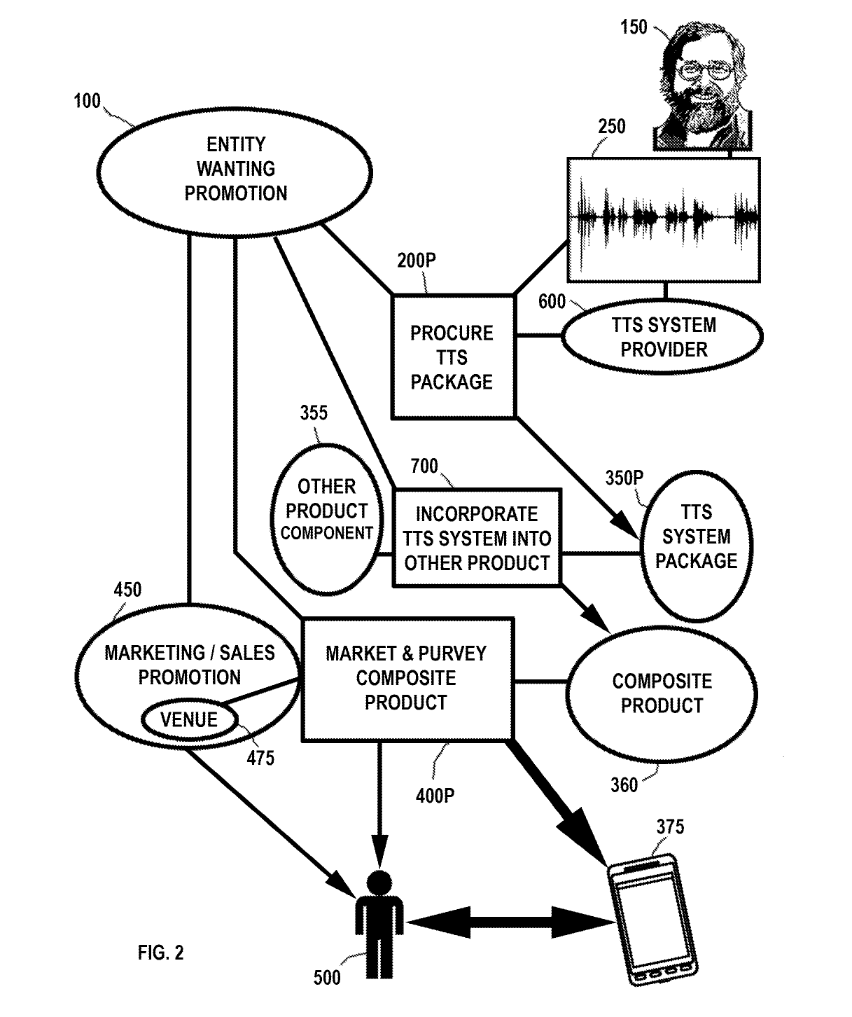

FIG. 2 shows an overall view of a second embodiment of the method, marketing & selling a Composite Product 360 that incorporates a TTS System Package 350P with an Other Product Component 355.

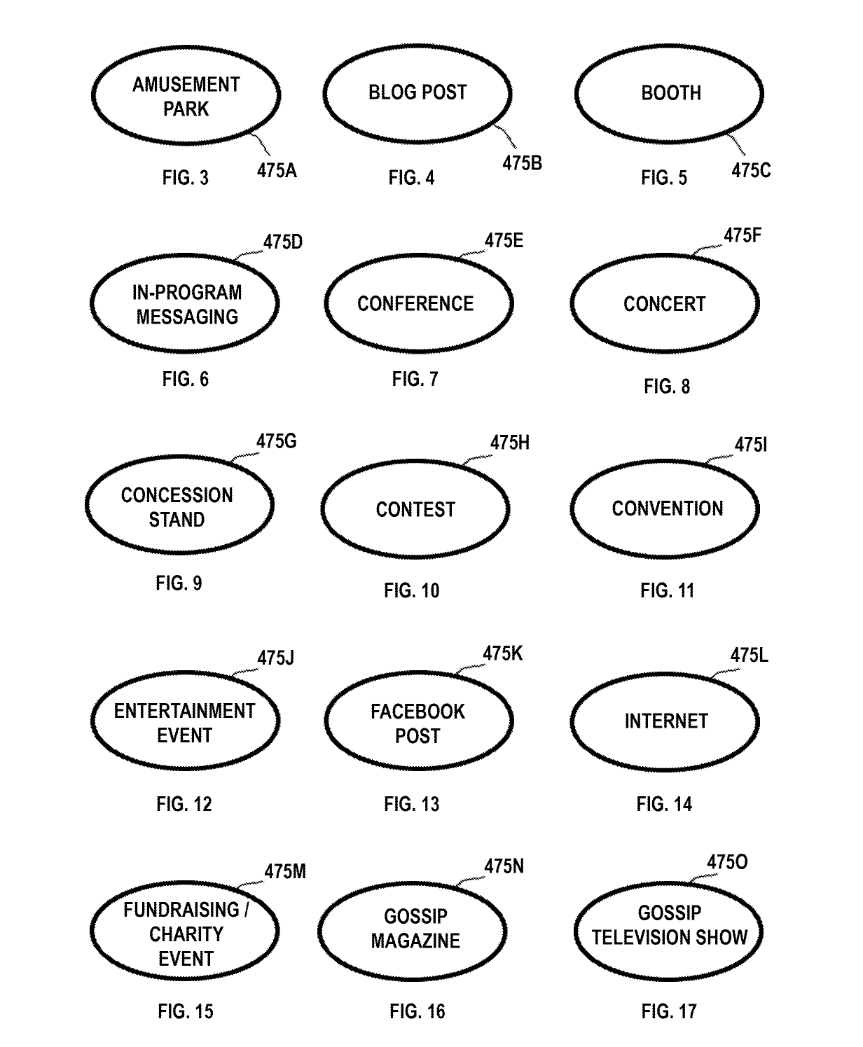

FIGS. 3-47 show partial views of alternative embodiments substituting various types of venues 475A-475SS for Venue 475.

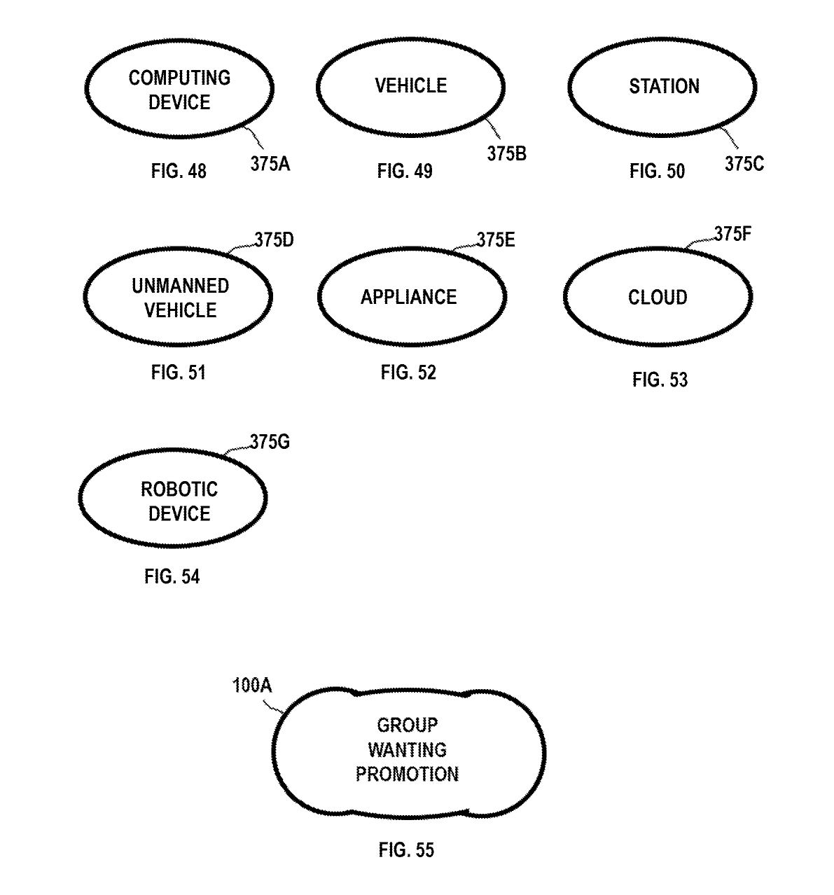

FIGS. 48-54 show partial views of alternative embodiments substituting various types of hardware devices 375A-375G for Hardware Device 375.

FIG. 55 shows a partial view of an alternative embodiment substituting a Group Wanting Promotion 100A for the Entity Wanting Promotion 100.

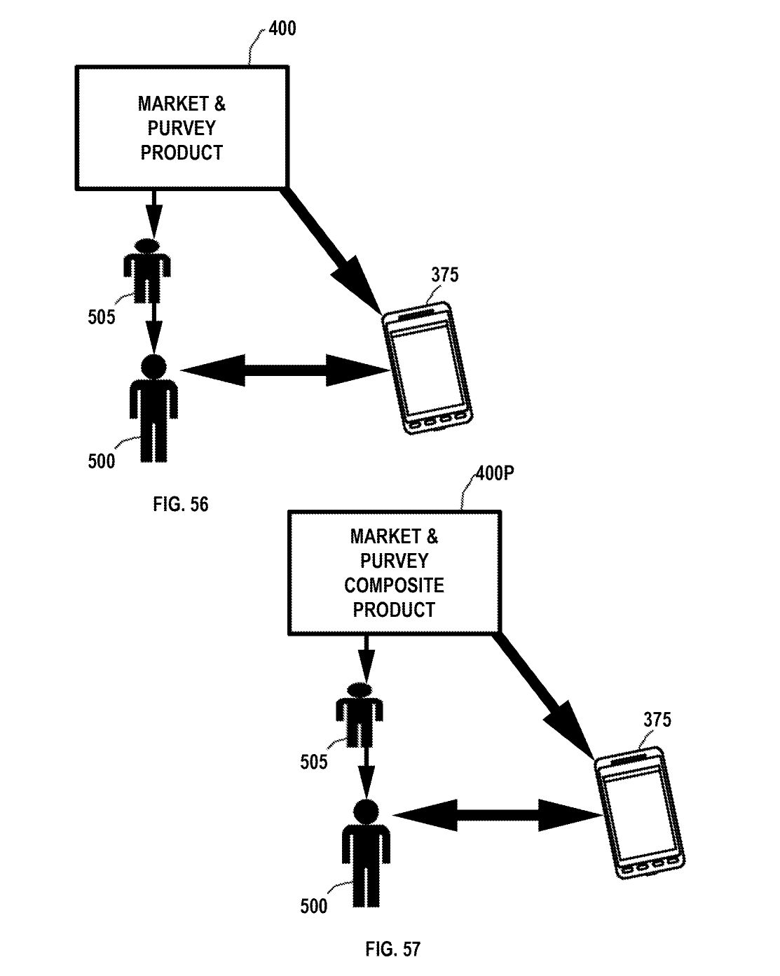

FIGS. 56-57 show partial views of alternative embodiments introducing an Intermediate Customer 505 as a middleman in the purveying process.

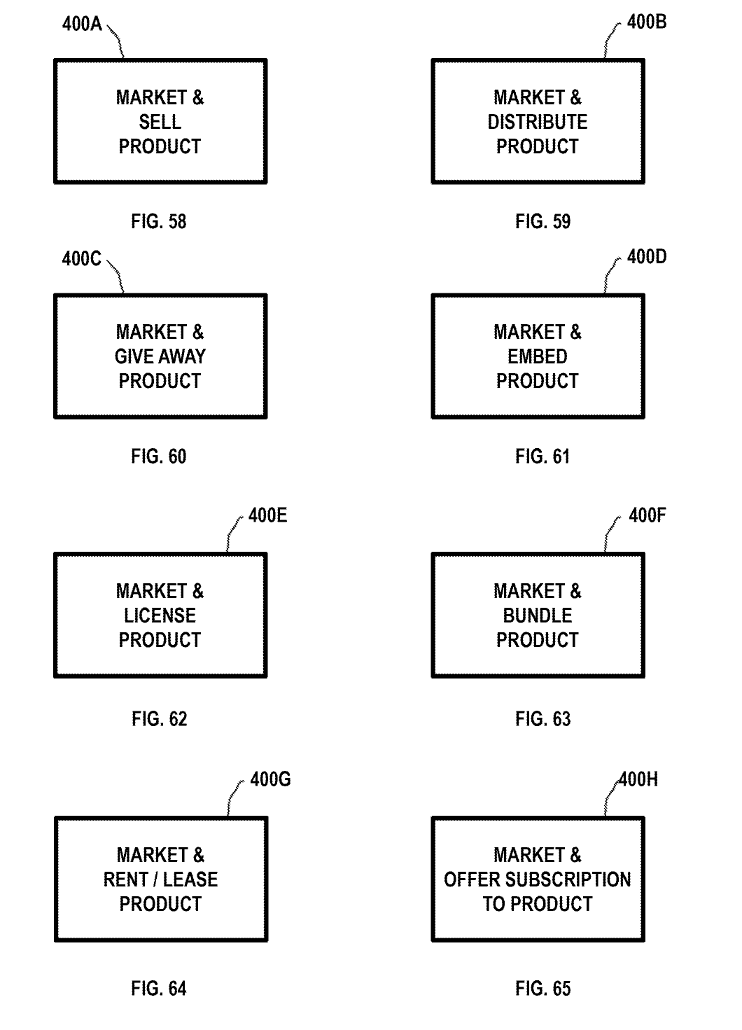

FIGS. 58-65 show partial views of alternative embodiments substituting various types of specialized purveying product actions 400A-400H for action Market & Purvey Product 400.

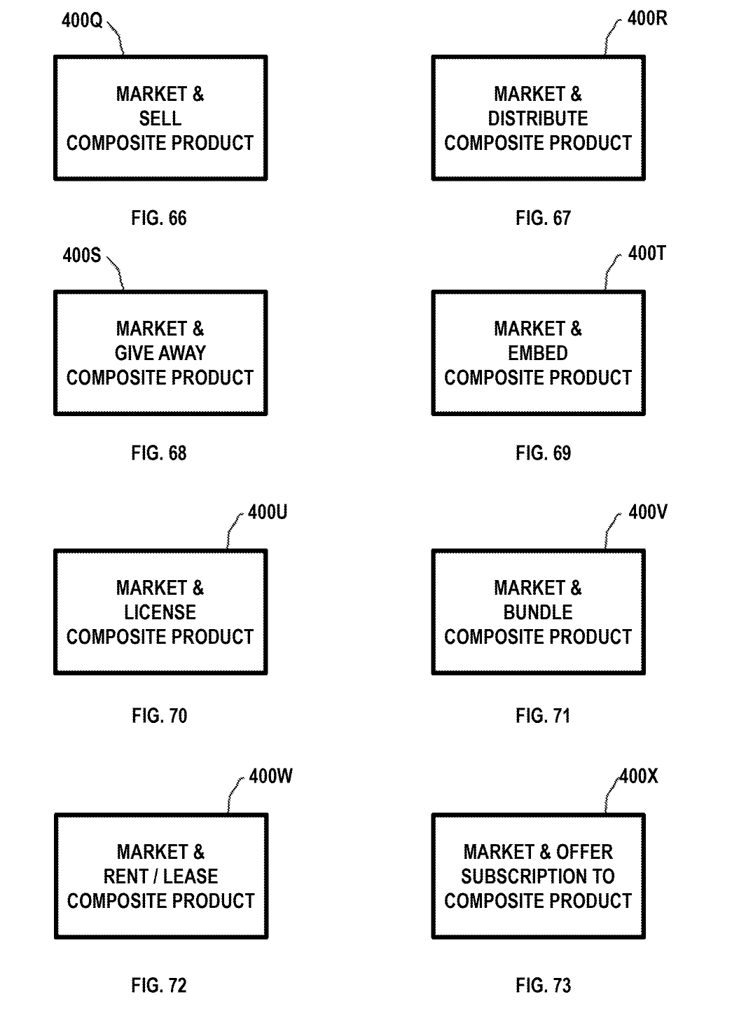

FIGS. 66-73 show partial views of alternative embodiments substituting various types of specialized purveying composite product actions 400Q-400X for action Market & Purvey Composite Product 400P.

### GLOSSARY

TTS A general Text-To-Speech system. A system that takes in general text, such as news reports, Twitter messages, or email contents, and emits sound waveforms of a voice speaking the text.
   A TTS can be embodied in software or hardware.
   It is possible for the sound waveforms to be sent to a computer file, and then played out later. However, almost always a TTS needs a hardware device, such as a speaker, to convert the sound waveforms into sound in the air. Software TTS systems also typically require a hardware device containing a computer, such as a smart phone, in order to have something to run on.
Marketing Although a broad term, in its purest sense this can mean making a customer aware of the existence and advantages of an entity, personality, product, service, event, experience, place, piece of information, or idea. Marketing includes advertising.
Market impressions A customer's experience of perceiving something having to do with the entity etc. being marketed. For instance, every time a customer pours a bowl of cereal, the customer sees the cereal brand name on the box. This counts as a marketing impression.
   Generally, the more impressions, the better. Also, the higher quality impressions, the better. So, the voice of a favorite personality on a favorite cell phone is an impression of high quality.
Fan A customer who likes a famous person.
Famous Person A celebrity, either already established or in the process of being established.
   Someone whom at least some fans recognize and admire. Should be already famous, or will be famous—must be known by the customer for doing something other than being a Text-To-Speech computer voice. This is what defines and creates ancillary merchandise for the fans.
   Contrast this against the generic personalities currently used by Apple, Android, and Amazon to help sell their smart phones. The voices were selected from largely unknown voice actors and actresses based on their ability to speak clearly. They do not represent a famous person. These voices and the actors behind them are hardly recognizable, and they are not famous for doing something else other than being a TTS voice.
Purvey Usually, to sell; also covers such things as distributing, renting/leasing, giving away for free, offering a subscription to, selling as a service, licensing, bundling, embedding, etc.
Ancillary Merchandise Something that is purveyed to a fan that is branded with a famous person, so that the fan can enjoy the personality. A primary product would be e.g. a movie, a concert, or an event, etc., which the person is appearing in, past, present, or future. I.e., something else that is making the personality attractive. Then the ancillary merchandise would be e.g. a T-shirt, a poster, a drinking glass, etc., sold for fans, often at the primary event.
   A good example is practically anything with Harry Potter printed on it.
Venue A “place” where things are marketed and purveyed. This is not just a physical location, but rather can be a conceptual channel.

### DRAWINGS

### Reference Numerals

100 Entity Wanting Promotion
100A Group Wanting Promotion
150 Famous Person
200 Procure TTS Product
200P Procure TTS Package
250 Voice Recording of the Famous Person
350 TTS System Product
350P TTS System Package
355 Other Product Component
360 Composite Product Incorporating TTS System Package
375 Hardware Device
375A Computing Device
375B Vehicle
375C Station
375D Unmanned Vehicle
375E Appliance
375F Cloud
375G Robotic Device
400 Market & Purvey Product
400A Market & Sell Product
400B Market & Distribute Product
400C Market & Give Away Product
400D Market & Embed Product
400E Market & License Product
400F Market & Bundle Product
400G Market & Rent/Lease Product
400H Market & Offer Subscription to Product
400P Market & Purvey Composite Product
400Q Market & Sell Composite Product
400R Market & Distribute Composite Product
400S Market & Give Away Composite Product
400T Market & Embed Composite Product
400U Market & License Composite Product
400V Market & Bundle Composite Product
400W Market & Rent/Lease Composite Product
400X Market & Offer Subscription to Composite Product
450 Marketing/Sales Promotion
475 Venue
475A Amusement Park
475B Blog Post
475C Booth
475D In-Program Messaging
475E Conference
475F Concert
475G Concession Stand
475H Contest
475I Convention
475J Entertainment Event
475K Facebook Post
475L Internet
475M Fundraising/Charity Event
475N Gossip Magazine
475O Gossip Television Show
475P Jumbotron
475Q Kiosk
475R Launch
475S Magazine
475T Meeting
475U Movie
475V Musical
475W Olympics Event
475X Opera
475Y Play
475Z Rally
475AA Race
475BB Reality Show
475CC Rodeo
475DD Email Campaign
475EE Sports Event
475FF Radio Broadcast
475GG Space Event
475HH Speech
475II Stage Production
475JJ Souvenir Place
475KK Store
475LL Commercial
475MM Show
475NN Twitter Tweet
475OO Theme Park
475PP Video
475QQ Wrestling Event
475RR Merchandise Store
475SS Training Event
500 Customer
505 Intermediate Customer
600 TTS System Provider
700 Incorporate TTS System into Other Product

### DETAILED DESCRIPTION

### First Embodiment—FIG. 1

FIG. 1 shows an overall view of one version of my Method for Marketing and Promotion Using a General Text-To-Speech (TTS) Voice System as Ancillary Merchandise.

### Parts of the First Embodiment—FIG. 1

There is one or more of an Entity Wanting Promotion 100. The Entity 100 wishes to obtain awareness, attention, and/or good will from one or more Customers 500—what is normally called marketing or promotion.

There are a large number of different categories of entities wanting marketing and promotion that are readily known to one familiar with the art. Some examples of these include the following: A recording label, music producer, or music management team wants to promote its singers. Singers or musicians want to promote themselves, or a tour. A political team wants to promote a political candidate or incumbent. Individual politicians want to promote themselves, and their message. Movie studios want to promote the launch of a new movie, or the relaunch of an old movie. Theme park corporations such as Disneyland or Knott's Berry Farm want to promote their parks, their rides, or one or more characters of the theme park. Television series want to promote their shows. Production companies want to promote the launch or continuation of a play, a musical, an opera, or a concert. Meeting production companies such as Comic-Con or Siggraph want to promote a convention, a conference, an event, a gathering, or a meeting. Reality stars such as Paris Hilton or Kim Kardashian want to promote themselves, a new show, or a branded product such as perfume or a computer game that they are associated with. Real estate moguls such as Donald Trump want to promote buildings, condominiums, hotels, casinos, resorts, parks, and events. Real estate development organizations want to promote development land sales and home sales. Estates want to promote the brand of their decedent. “Motivational speakers” such as Tony Robbins or Mark Victor Hansen want to promote their presentations, their concepts, and their self-help package products. Marketing/copy writing/efficiency consultants, and other consultants, want to promote their services. Armed forces and police forces want to promote their way of life, and enlistment. Countries want to promote their culture. Philanthropists/charity organizations want to promote charity drives, fund-raising efforts, events, and causes. Movie stars want to promote themselves, the entertainment properties they're in, and their causes. Universities, colleges, and schools want to promote their experience. Hedge funds, banks, and investment houses want to promote the services they offer. Restaurants, fast-food restaurants, franchises, hotels, and stores want to promote what they have to offer. Religious organizations want to promote themselves and their lifestyle. Discos, dance halls, raves, meetups, dance events, and museums want to promote their events. Sports teams, and corporations behind sporting events such as the SuperBowl or the Indianapolis 500, want to promote their brand and their events. Disk jockeys, radio programs, news programs, and television programs want to promote awareness of their offerings. Athletes and other celebrities want to promote themselves and the activities they're associated with. Clothing chains want to promote special events, their brand, and their product line. Comic-book companies and animation companies want to promote their products, their shows, their characters, and their branding. Internet stores, Internet portals, website owners, and blog owners want to promote their websites and their offerings. YouTube and streaming video stars, show owners, and channel owners, want to promote themselves, their brand and their offerings. These are all examples of Entities Wanting Promotion 100. Other examples are obvious to a person skilled in the art.

The Entity Wanting Promotion 100 may also be a company offering or launching a product or service with an associated TTS system product or service that uses the voice of a famous personality. For example, this could be a refrigerator, washing machine, oven, or other appliance-making company, etc.; a company offering land, sea, air, underground, undersea, under-ice, in-lava, interplanetary, or space vehicles, such as cars, trains, buses, trucks, campers, boats, airplanes, blimps, zeppelins, helicopters, quadrotors, monowings, gliders, submarines, subways, drilling vehicles, earth-moving and other heavy machinery, floating or fixed oil wells, space shuttles, space stations, etc; a company offering partially-managed or autonomous self-directed robotic or “drone” vehicles, whether for land, sea, air, underground, undersea, under-ice, in reactor, in lava, interplanetary, or space vehicles, such as autonomous cars, Unmanned Ground Vehicles, Unmanned Aerial Vehicles, Unmanned Combat Aerial Vehicles, Unmanned Surface Vehicles, Unmanned Undersea Vehicles, Automatic Train Operation driverless trains, Unmanned Spacecraft, robotic probes, Driverless Tractors and other unmanned/robotic heavy machinery; a company offering intelligent assistants; a company offering humanoid, factory, military, or non-humanoid robots; and so forth. Other examples of Entities Wanting Promotion 100 are obvious to a person skilled in the art.

A Famous Person 150 is a person who has a particular voice that people will be able to recognize. Since we are dealing with ancillary merchandise, the person must be famous for their personality, who they are, or what they've done; the person cannot be famous merely for being a voice in a computer, which would be primary not ancillary merchandise.

Usually the Famous Person 150 will already be famous, or at least well-known to a particular group of fans. However, for instance with a new movie or a new singing star, sometimes the Famous Person 150 is in the process of launching to become famous, and so the publicity itself will feed the fame.

Usually the Famous Person 150 will be an actual living human being. There are many examples of Famous Persons 150, including singers; musicians; actors and actresses; activists; astronauts; celebrities; chefs; comedians; entertainers; television commercial spokespeople; disk jockeys (DJs); company owners; millionaires or rentiers; famous investors or philanthropists; religious leaders; psychology or health leaders; doctors; television personalities and talk show hosts; bankers and public figures; “reality” stars; heirs and heiresses; “motivational speakers”; butlers, maids, and production assistants; present and former movie stars; stage actors; musical or opera singers; real estate moguls; people worth over a million dollars; marketing and other consultants; famous policemen, soldiers, or firefighters; songwriters; spokespeople for countries, universities, colleges, or schools; cheerleaders; race car drivers; spokespeople, founders, or famous executives of hedge funds, corporations, restaurants, fast food chains, or franchises; managers; athletes, referees, team owners, or newscasters; people who have become famous by appearing in YouTube videos or on TV or in the news; Youtube bloggers; fashion models and photography models; radio announcers; talk show hosts, e.g. for TV, radio, or Internet; blog owners; deceased celebrities; specialists and people who have become well-known because of a niche specialty, etc. Any one or combination of these is an example of the Famous Person 150. Many other variations are possible.

The Famous Person 150 may even be deceased, if there are enough good-quality recordings of his or her voice. An example here would be Michael Jackson or Paul McCartney.

Sometimes the Entity Wanting Promotion 100 and the Famous Person 150 will be embodied in the same natural human being. However, usually the Entity Wanting Promotion 100 will be a business corporation, and the Famous Person 150 may sometimes be a pseudonymous stage presence, so these are normally disjoint.

These all are some examples of Famous Persons 150. Other examples are obvious to a skilled person.

A Voice Recording Of The Famous Person 250 is a digitized set of raw data, a voice recording of the Famous Person 150, that will be used to create a Text To Speech voice. This is the raw material used to make a voice. It should be a clear recording. It should contain examples of all of the phonemes normally used in everyday pronunciation of a language. Ideally, it should contain examples of all diphones as well. The Voice Recording must be of sufficient clarity, length, variation, and quality such as to be able to support sufficient mining or training of pronunciation sounds in order to be able to make a TTS voice of production quality.

It is not necessary for the Famous Person 150 to still be alive, as long as the Voice Recording of the Famous Person 250 contains all the data necessary to create a good voice.

The Voice Recording Of The Famous Person 250 is obtained in the usual way by one skilled in the art. For example, a recording engineer might sit down with the Famous Person 150 in a recording studio with a microphone and a recording digitizer, and generate the Voice Recording 250. Or a recording device can be put on a phone, and the Famous Person 150 can call in and have their voice recorded. Or voice recording samples can be gathered from previous practice sessions or recording sessions. Other examples of how to obtain the Voice Recording 250 will be obvious to one skilled in the art.

A Text-To-Speech TTS System Provider 600 is a one-or-more-person team or department that is adept at taking a voice recording and generating a TTS software system from it. Such teams exist at least at Google, Apple, the Ivona team owned by Amazon, and DragonLord Enterprises, Inc. The TTS System Provider 600 may be a team that is owned by or part of the Entity Wanting Promotion 100, or it may be an outside team.

As an example of this transformation, the TTS can be built using diphone technology. First, download and install the Festival and Edinburgh Speech Tools systems from The University of Edinburgh site http://www.cstr.ed.ac.uk/projects/festival/ onto a Linux-based development computer. Download the associated Carnegie-Mellon University FestVox voice development system from http://festvox.org/download.html, and follow its instructions. Carnegie-Mellon provides open source to the Flite C speech engine that uses files in the FestVox format, at cmuflite.org or http://www.festvox.org/flite/. CMU also provides the source for a Java version of Flite that runs on the Android™ OS, e.g. at http://github.com/happyalu/Flite-TTS-Engine-for-Android. A programmer skilled in the art can then craft a TTS System Product 350 to run on a Hardware Device 375.

Often the TTS System Provider 600 will have its own protocols and its own custom script for recording the Famous Person 150 in order to obtain the Voice Recording 250.

An action Procure TTS Product 200 is an action step of the Method that is taken to obtain a TTS Product 350. The Voice Recording Of The Famous Personality 250 is necessary. The TTS System Provider 600 is used in this step to come up with a TTS system product. Using a team involves calling them up, explaining the production required, getting a bid, selecting the provider, and turning them loose on the project. Using such a team, whether external or internal, is straightforward to one skilled in the art. The main part of this action is procuring the TTS product. It is also possible to procure a TTS product off the shelf, if a satisfactory one has been built using the Famous Person 150's voice already. In this case, the TTS System Provider 600 has already done its work in the past. This is just one example. Performance of this action step is straightforward to one skilled in the art.

A TTS System Product 350 is then a consumer-ready product that is the result of the action step Procure TTS Product 200. It uses a general Text-To-Speech voice that replicates the voice of the Famous Person 150. It can be sold as a product. It is sold as ancillary merchandise—something to keep the fans of the Famous Person 150 happy. Although the TTS System Product 350 can be any product that makes use of a TTS, in its simplest form it is just a voice plugin that transforms text, obtained from some source such as email, SMS, Twitter, the web, or driving instructions, into speech, in the voice of the Famous Person 150. But it could be a TTS System Product 350 that offers more capability, such as the power to obtain or download email before speaking it, the power to browse and download Twitter Tweet messages, the power to surf the web and decide which pages to speak, the power to plan routes, the power to listen and hold conversations, the power of planning or giving advice, etc. These are just some examples of a TTS System Product 350.

The TTS System Product 350 is generally dedicated to the particular hardware or operating system that a consumer is going to be using. For example, the Android operating system allows a TTS product to be a voice that is installed as a plugin at the system level. The user selects the voice, upon installation, using the Settings control panel. Then, any app that runs on that Android phone, that uses TTS, can use that TTS voice for output. As another example, the Apple operating system supports a TTS product that runs as a stand-alone app. Then the app gets its own text, perhaps from a popup screen that asks the user to type on it, or from other sources. The app feeds this text into the TTS system, and speaks out the results as sound output. The product does not even have to be a software product, it could be a hardware product, such as a TTS board or chip, etc., that gets installed in a hardware device. These are some examples of a TTS System Product 350. Other examples will be obvious to one skilled in the art.

A Market & Purvey Product 400 action step declares the TTS System Product 350 to be ancillary merchandise, and markets & purveys the TTS System Product 350 to customers. The purveying is usually selling, although for example it could be rent/leasing, making available to give away, offering as a subscription service, etc. Alternative specialization embodiments for purveying will be presented in FIGS. 58-73. A customer has to know about the Product 350, which is the marketing part, and a customer has to be able to buy, get, or obtain the Product 350, which is the purveying part. Marketing & Purveying is an action well known to those skilled in the art. For example, marketing the Product 350 might be done by having the Famous Person 150 discuss the product on Twitter, on Facebook, on Youtube, or in other social media. Or, marketing could be done by advertising on TV, or in newspapers. The product can also be listed on a web page in the Google Play Store, in the Apple iTunes apps store, or on Amazon. This makes the Product 350 available for download.

As another example of how the Market & Purvey Product 400 action step can be performed, a singer, politician, announcer, or someone else on stage, on television, on radio, or on an Internet, video, Twitter, Facebook, or multimedia presentation can announce that the TTS System Product 350 is available. Marketing & Purveying posters at an event can also announce that the product is available. Salesmen, assistants, or docents can also announce that the product is available; or assist downloads.

Some other examples of channels to Market & Purvey Product 400 include: direct-response online, email, or regular mail marketing; social media, blogs, and video; search engine marketing; inserts, magazine ads, catalogs, and print advertising; radio; television, including such things as broadcast, cable and streamed; telephone conversations and telemarketing; event marketing; public relations; paparazzi, and tabloid magazines; special joint ventures; Twitter campaigns; etc.

Typically, instructions for buying and downloading the product will be communicated at the same time. However, sometimes purveying the product will be done over a different channel than marketing the product. For instance, at a concert or event, an announcer or the Famous Person 150 can market the Product 350 and make fans aware of it, then ask the fans to go to a sales booth in order to get help in buying and downloading the product.

These are just some examples of how to Market & Purvey Product 400. Other examples will be obvious to one skilled in the art.

The act of Market & Purvey Product 400 de facto creates a Marketing/Sales Promotion 450, which is the abstract entity or intangible thing that is the concept of the TTS System Product 350 being marketed and purveyed. However, because the TTS System Product 350 is being purveyed as ancillary merchandise, the Marketing/Sales Promotion 450 is often larger than simply the Market & Purvey Product 400 action. It is often an overall, full marketing/sales campaign.

For example, an Entity Wanting Promotion 100 that is a movie studio launching a new movie will typically take out Internet ads, bus posters, and billboards advertising the movie. Using this Method, the Entity 100 will also Market & Purvey 400 the Product 350, that contains the voice of the Famous Person 150, as ancillary merchandise, along with the other ancillary merchandise that is being sold in order to promote the movie, thereby forming a Marketing/Sales Promotion 450. Of course this Market & Purvey Product 400 action may be repeated one or more times, for each of one or more Famous Personalities 150, included in a single Marketing/Sales Promotion 450.

As another example, an Entity 100 who's a singer wanting to get closer to her fans could simply advertise the TTS Product 350 for sale on her Twitter page, or on her website. This then would count as both the Market & Purvey Product 400 action step, and as a small Marketing/Sales Promotion 450. However, she could also do this as part of a grand marketing roll-out for an elaborate concert tour, with many different types of ancillary merchandise in addition to the TTS System Product 350. In this case, the Marketing/Sales Promotion 450 would be larger than the Market & Purvey Product 400 action.

Selling may be done directly; it may be done through one level of store; or it may be done through more than one level, e.g. in a wholesale/retail relationship, as is well known to those skilled in the art.

Other examples of Marketing/Sales Promotion 450 will be apparent to one skilled in the art.

Part of the Marketing/Sales Promotion 450 is one or more Venues 475 at which the Market & Purvey Product action 400 takes place.

Previously, TTS voices have either been sold as technology embedded in cell phones, computers, or tablets, or in the app store section of the Google Play or the Apple iTunes website, where they compete against hundreds of thousands of various other cell phone apps.

However, selling a TTS System Product 350 as ancillary merchandise opens up a much wider range of possibilities. For example, currently Google Play has different categories for Apps, Music, Movies, and Books; and both the Apple and Amazon stores have similar categories as well. When TTS voices are sold as ancillary merchandise, they could for instance be listed in the Music section of these catalog categories. This is one example of a Venue 475. Or, alternatively, there could be a separate category for Voices. iTunes sold around 22 million downloads of music a day in 2013, for roughly $10 billion gross. Creating a separate catalog category of Voices, as ancillary merchandise to be purchased and downloaded, would create a new Venue 475 that potentially could eventually match this figure.

The Venue 475 is a location or channel through which the marketing and purveying messages are conveyed. It does not have to be a physical channel, such as a merchandise kiosk or concession stand, etc., but rather can alternatively be a conceptual channel, such as radio commercials, blog posts, or viral videos, etc. There can be one or more venues in play at the same time.

Further examples of alternative embodiments for venues are shown in FIGS. 3-47, to be discussed.

These are just some examples of Venue 475. Further examples will be apparent to one skilled in the art.

A Customer 500 is a person, corporation, institution, organization, foundation, government, or group, etc, that obtains the TTS System Product 350. Typically the Customer 500 is a fan of the Famous Person 150, whether from the past, or a new fan. The Entity Wanting Promotion 100 is causing the TTS System Product 350 to be Marketed & Purveyed 400 as ancillary merchandise, as part of its Method For Marketing And Promoting; as part of its Marketing/Sales Promotion 450; and usually, also, to make a profit. Purveying the TTS System Product 350 to the Customer 500 thus creates Marketing and Promoting for the Entity 100.

A Hardware Device 375 is used by the Customer 500, or the Customer 500's assigns, to host the TTS System Product 350; run its 350 software or hardware; and create sound. There are many different examples of Hardware Device 375 that can benefit from having a TTS System Product 350. In one example, the Hardware Device 375 is a smart phone. Other alternative embodiments are shown in FIGS. 48-54, to be discussed.

### Connections and Interactions of the First Embodiment—FIG. 1

The Method for Marketing and Promoting has two main action steps in this first embodiment:

Procure TTS Product 200, and

Market & Purvey Product 400 as ancillary merchandise.

These are supported by the various entities shown in FIG. 1 and discussed in these sections.

The Entity Wanting Promotion 100 wishes to use the Famous Person 150 in creating a TTS System Product 350 reproducing the Famous Person 150's voice, in order to Market & Purvey Product 400 to the Customer 500 for use on the Hardware Device 375. To do this, two steps are performed in this embodiment: (1) Procure TTS Product 200, and (2) Market & Purvey Product 400. The second step is all or part of a Marketing/Sales Promotion 450 to the Customer 500. In this way, the Entity Wanting Promotion 100 achieves marketing and promoting.

The Famous Person 150's voice is or has been recorded to result in the Voice Recording 250. The attributes of the Famous Person 150, including for instance one or more of the name, face, appearance, reputation, characteristics, voice, etc., are used in the Market & Purvey Product 400 action step to market to the Customer 500. The Customer 500 receives marketing impressions from and may derive familiarity and enjoyment from hearing the voice of the Famous Person 150 every time the TTS System Product 350 is used by the Customer 500 on the Hardware Device 375.

The Voice Recording 250 of the Famous Person 150 is raw material for the present or past creation of the TTS System Product 350. The Voice Recording 250 is used by the TTS System Provider 600 in the process of providing a TTS System Product 350 for the Procure TTS Product step 200.

The TTS System Provider 600 is responsible for providing the TTS System Product 350 to run on the Hardware Device 375. This is done by transforming the Voice Recording 250 into a TTS System Product 350 in a matter familiar to one skilled in the art. Then this will be declared to be ancillary merchandise in the Market & Purvey Product step 400, and marketed & purveyed as such. Sometimes the TTS System Provider will help get the Voice Recording 250 by recording this from the Famous Person 150. Sometimes the TTS System Provider will already have one or more components of a TTS System Product and then merely provide them. This Product 350 is usually created in a custom manner based on the requirements of the Entity Wanting Promotion 100 or the Marketing/Sales Promotion 450. However, another example of how the TTS System Provider 600 can do its job is to provide one or more already-existing systems, components, software, data, parts, or products which have already been built, including the case of a previously-built TTS System Product 350 already built from a Voice Recording 250 of the Famous Person 150 in the past.

Procuring the TTS Product 200 entails getting the TTS System Provider 600 to provide a TTS System Product 350 that is based on the Voice Recording 250, for the benefit of the Entity Wanting Promotion 100. The end result of the Procure TTS Product 200 step is the TTS System Product 350 that is ancillary merchandise that uses the voice of the Famous Person 150.

The TTS System Product 350 is obtained by the Procure TTS Product 200 step. It is the object of the Market & Purvey Product 400 step, and gets sold to the Customer 500, for delivery to, installation in, and use in the Hardware Device 375.

The Market & Purvey Product 400 action step declares the TTS System Product 350 to be not just a voice, but ancillary merchandise. This action step 400 markets and purveys the TTS System Product 350 to the Customer 500, on behalf of the Entity Wanting Promotion 100, at the place of or through the channel of the Venue 475. Upon obtaining it, the TTS System Product 350 is installed in the Hardware Device 375. For example, with software systems, this is typically done by a downloading happening automatically upon sale. Another example is the Customer 500 installing and configuring the TTS System Product 350 into the Hardware Device 375 himself or herself. Another example, when the TTS System Product is in a hardware board, card, or a chip, etc., is the Customer 500 installing the board, card, or chip etc. into the Hardware Device 375 by himself or herself. Another example is the TTS System Product being installed by assistants, clerks, or technicians etc. in the Market & Purvey Product 400 process. Other examples include the Customer 500 embedding the TTS System Product 350 into specially created hardware or software in the Hardware Device 375.

Performing the Market & Purvey Product 400 action step de facto creates at least a small Marketing/Sales Promotion 450. However, the Market & Purvey Product 400 step is often part of a larger Marketing/Sales Promotion 450 campaign, which may merely include selling the Product 350 as ancillary merchandise to obtain marketing and promotion as a part of a complex whole.

Thus, the Marketing/Sales Promotion 450 targets the Customer 500 on behalf of the Entity Wanting Promotion 100, reaching the Customer 500 through one or more Venues 475. At least one component of the Marketing/Sales Promotion 450 is the act of Market & Purvey Product 400 as ancillary merchandise, based on the strength of the Famous Person 150.

The Venue 475 is used by the Market & Purvey Product 400 action, as part of the Marketing/Sales Promotion 450 campaign, to communicate the Promotion 450 to the Customer 500, in particular the news about the Product 350, and to purvey the Product 350. Although Marketing & Purveying can be done at the same time through the same Venue 475, it is possible to split these apart into different Venues 475 and market through one or more Venues 475 while purveying through one or more possibly separate Venues 475.

The Customer 500 is the target recipient of the Marketing/Sales Promotion 450, through the one or more Venues 475. In particular, the Customer 500 is the target recipient of the Market & Purvey Product 400 action. The Customer obtains the TTS System Product 350 through the action of Market & Purvey Product 400, and causes the Product 350 to be installed on the Device 375. The Customer 500 also uses and interacts with the Hardware Device 375, obtaining the benefit of a Device 375 that talks with the voice of the Famous Person 150. The Customer 500 potentially receives marketing and promotion through two aspects: by perceiving the Market & Purvey Product 400 Marketing/Sales Promotion 450, and by listening to the voice of the Famous Person 150 in the TTS System Product 350 in the Hardware Device 375 on an ongoing basis.

The Hardware Device 375 gets the TTS System Product 350 installed in it, for example through a download or other familiar means, etc., when the customer buys and takes delivery of the Product 350 as the recipient of the Market & Purvey Product 400 action. The Hardware Device 375 also interacts with and is used by the Customer 500, giving the fan Customer 500 the benefit of listening to the voice of the Famous Person 150. The TTS Product 350 on the Hardware Device 375 will typically be used by the Customer 500 often, on an everyday or weekly basis, in some cases for years on end.

In this way, Procuring a TTS Product 200, and Marketing & Purveying Product 400 as ancillary merchandise based on the strength of the Famous Person 150, make up the essence of the Method for Marketing and Promoting.

### Operation of the First Embodiment—FIG. 1

The function of this Method is to create marketing and promotion by means of Marketing & Purveying 400 the Text-To-Speech (TTS) System Product 350 as ancillary merchandise that reads text with the voice of the Famous Person 150.

This effect comes about through two main aspects.

First, because the Famous Person 150 is attractive and exciting to his or her Customer fans 500, the Marketing/Sales Promotion 450 including the step Market & Purvey 400 the TTS Product 350 gives an excuse for e.g. the Entity Wanting Promotion 100 to talk about the Product 350 and to create the Marketing/Sales Promotion 450 in various Venues 475 around the Product 350 sold as ancillary merchandise. The Entity Wanting Promotion 100 is not just using the Famous Person 150 in a publicity campaign to get more promotion; the Entity 100 is in fact using the TTS System Product 350 of the voice of the Famous Person 150 as exciting ancillary merchandise that the Customer 500 can obtain. So the discussion of the Marketing/Sales Promotion 450 can center not only around the Famous Person 150, and the Entity Wanting Promotion 100, but also in particular around the TTS System Product 350 sold as ancillary merchandise. This gives more attention-grabbing material to talk about.

Of course, this applies both to Customers 500 who already know that they are fans of the Famous Person 150, and Customers 500 who are not yet aware that they are fans of the Famous Person 150, but are going to be. The essence of a launch, especially for a new star, is to bring out lots of ancillary merchandise to sell, so that the fan Customer 500 is able to vicariously participate in the path and destiny of the Famous Person 150. So the TTS System Product 350 declared to be ancillary merchandise can now be an important part of this Promotion 450 campaign package.

This first aspect is simply promotion through the act of promotion (including Marketing & Purveying 400) itself. However, the power of the second aspect of selling the Product 350 as ancillary merchandise for marketing and promotion comes through the ongoing use by the Customer 500.

The long-term value of ancillary merchandise as promotion comes through how actually useful the product is. A product like a pull-string doll is not very useful, and will be discarded after its novelty wears off. But a product like the TTS System Product 350 is something that can be used by the Customer 500 every day for years on end, and its usefulness will still not wear out. Given the proper app, running on the Hardware Device 375, the Customer 500 can listen to news, an RSS feed, or the weather being read out while the Customer 500 is driving to work. So this gives marketing impressions to the Customer 500 on an everyday basis, every time the Customer 500 uses the voice in the TTS System Product 350. This gives the Customer 500 pleasure, and powerfully acts to remind the Customer 500 of the Famous Person 150, the Marketing/Sales Promotion 450, and the Entity Wanting Promotion 100 that was able to make this beneficial Product 350 available to the Customer 500. When the Hardware Device 375 is the Customer's 500 smart phone, or another favorite hardware device, this acts as a very personal contact on a long-term basis.

As smart phones, the Internet of Things, and robotic devices grow in intelligence, the significance of a Hardware Device 375 that talks in the voice of a favorite Famous Person 150 can only increase.

The situation is usually driven e.g. by the Entity Wanting Promotion 100. There should be someone, or a corporation, or something, etc., that wants to achieve marketing and promoting.

Operation of the Method then comes in two action steps: (1) Procure the TTS Product 350 that uses the voice of the Famous Person 150, and (2) Market & Sell the TTS Product 350 as ancillary merchandise, based on the strength of the reputation of the Famous Person 150.

Action step Procure TTS Product 200 is done by finding or putting together a team with one or more people, teams, groups, departments, or companies, whether internal or external, capable of providing a TTS system 600 given a sufficient Voice Sample 250 of the Famous Person 150. The final outcome from this is a saleable TTS System Product 350.

As mentioned, usually the TTS System Provider 600 will create the Product 350 de novo. However, if TTS system components already exist, or the data or parameters for a TTS system incorporating the voice of the Famous Personality 250 already exist, or productization components already exist, or the finished TTS System Product 350 already exists, then, in this case, the provider 600 appropriately may merely provide the existing portions from past creation, instead of creating those portions in the present de novo. The key to this step is to Procure a TTS Product 200, the details of which are well known to one versed in the art, with the provision that the TTS System Product 350 be merchandise that highlights and uses the voice of the Famous Person 150, as generated from the Voice Samples 250. And so the end result of this step 200 is the saleable TTS System Product 350.

Often the TTS System Provider 600 will direct the obtaining of the Voice Sample 250 from the Famous Person 150 to ensure it is of sufficient quality and quantity. For example, the TTS System Provider may provide a custom script, e.g. the “Harvard Sentences”, for the Famous Personality to read out loud while being recorded. Or, the System Provider may employ a random-syllable prompting and recording system, such as is found in CMU's FestVox system, found on the web at www.festvox.org. The methods of obtaining the sufficient Voice Sample 250 are known to those skilled in the art.

In the case that the Famous Personality is no longer living, the TTS System Provider 600 will take existing Voice Samples 250 and create a transcript of them. The Provider 600 will then match the transcript to the Voice Samples 250, and obtain alignment on needed parameters, for example such as phonemes, diphones, triphones, pitch, volume, and so forth. These should be of sufficient quality to then allow the TTS System Provider 600 to be able to then do its job. Again, these methods are known to those skilled in the art.

The TTS System Provider 600 is going to consider such things as the target language of the user for any written instructions; the target Hardware Device 350 platform, whether it is using an Android OS, an Apple iOS, a Linux or Unix OS, a Windows OS, or some other kind of Operating System; and how the Product 350 is going to be packaged, delivered, and installed. The resulting Product 375 should be tuned for each of these considerations. These methods are again well known to those skilled in the art.

Once the TTS System Product 350 has been procured, the second action step is to Market & Purvey Product 400.

An example of this is to list the Product 350 for sale on the Google Play website catalog. This handles selling, downloading and installation into Android smart phone Devices 375. Then have the Famous Person 150 and/or the Entity Wanting Promotion 100 post a tweet on Twitter notifying the world of the TTS System Product 350 for sale. Or, the catalog address can be displayed on a Jumbotron, etc.

Often the Entity Wanting Promotion 100 is already engaged in a larger Marketing/Sales Promotion 450, in various Venues 475. For example, a political nomination committee may already be marketing and promoting their chosen politician candidate. As other examples, a record label may already be marketing and promoting their favorite singer, and a movie studio may already be marketing and promoting a new movie that is coming out starring an upcoming actor. In these cases, the Market & Purvey Product 400 action step will fit in to the existing Marketing/Sales Promotion 450 campaign. Having Procured the TTS Product 200, then Market & Purvey Product 400 as ancillary merchandise is done, for example, by mentioning the TTS System Product 350 in various advertisements in various Venues 475; by announcing at rallies, concerts, or events that the Product 350 available; by putting out press releases, buzz campaigns, viral campaigns, video campaigns, and other attention-getting marketing tactics that Market & Purvey 400 the Product 350; by holding fund-raising drives and events; etc. Other examples of how to Market & Purvey Product 400 are well known to those skilled in the art.

Since the TTS System Product 350 is ancillary merchandise, it can be Marketed & Purveyed 400 through Venues 475 that other ancillary merchandise is sold through, which significantly expands the possibilities for ways to sell a TTS System Product 350. For example, the Product 350 may be sold at charity, foundation, or public television fundraising events; at music concerts; at musicals, operas, plays, or performances; at movie launches; through direct mail or email campaigns; through ancillary merchandise catalogs or websites; on TV talk shows; in department or convenience stores; at motivational or training meetings or events; at souvenir shops and theme parks; on cruise tours and at vacation and gambling destinations; at trade shows, conventions, and conferences; in bookstores, coffee houses, and fast food restaurants; at sports events, whether live or broadcast; at activist and political rallies; etc. These alternative embodiment possibilities are illustrated further in FIGS. 3-47, and discussed further below. Getting the Product 350 as ancillary merchandise into the hands of the Customer 500 through these Venues 475 supports many new broadened opportunities for the Customer 500 to enjoy hearing the Famous Person 150, thus creating Marketing and Promoting.

### Second Embodiment—FIG. 2

FIG. 2 shows an overall view of a second embodiment of my Method for Marketing and Promoting using a General Text-To-Speech (TTS) Voice System as Ancillary Merchandise. This embodiment contrasts against the just-discussed first embodiment in which the TTS System Product 350 itself is purveyed by being sold, given away, rented, or offered as a subscription directly. Instead, a TTS System Package 350P is procured 200P. The Package 350P, for example, may be of product quality like before, or it may be of OEM quality, or a software library, etc. Then this TTS System Package 350P is incorporated into another product, through licensing, by embedding, or through being bundled, etc., resulting in a combined Composite Product Incorporating TTS System Package 360. Then this Composite Product 360 is Marketed & Purveyed 400P to the Customer 500 for use on the Hardware Device 375. The action steps are modified accordingly.

### Parts of the Second Embodiment—FIG. 2

Some of the parts in the first embodiment are found unmodified in the second embodiment, including: the Entity Wanting Promotion 100; the Famous Person 150; the Voice Recording 250; the TTS System Provider 600; the Marketing/Sales Promotion 450; the Venue 475; the Customer 500; and the Hardware Device 375. These are included in FIG. 2 for clarity.

A TTS System Package 350P needs to be procured. Like the TTS System Product 350, this is a professional software package that performs Text To Speech in the voice of the Famous Person 150. However, the TTS System Package 350P in some examples may not be required to be a stand-alone consumer-facing product, with an installer, etc. Instead, it is necessary that the TTS System Package 350P be of sufficient quality such that it can be incorporated into another composite product, in a system integration effort, such that the capabilities of the TTS System Package 350P are promoted as ancillary merchandise. This can be done e.g. through licensing, through bundling, or using the TTS System Package 350P as an embedded component, etc. See the examples in the Operations section and further alternative embodiments in FIGS. 66-73, below.

A Composite Product Incorporating TTS System Package 360 is then a product offering (including, for example, without restriction, tangible products, software products, or services offered as products, etc.) that employs the voice of the Famous Person 150 in a Text To Speech system, and is thus marketed & purveyed as auxiliary merchandise. For example, the TTS System Package 350P may be licensed and installed in another product, to result in the Composite Product 360. As another example, the TTS System Package 350P may be embedded in another product, to result in the Composite Product 360. As another example, the TTS System Package 350P may be bundled with another product, to result in the Composite Product 360. Then the Composite Product 360 is sold as auxiliary merchandise, featuring the Famous Person 150.

An Other Product Component 355 is another product (including possibly a service offering) that gets incorporated with the TTS System Package 350P to form the Composite Product 360. For example, the Other Product Component 355 could be a stand-alone product by itself, or it could be a partial component that needs the TTS System Package 350P for completion in order to become a Composite Product 360, etc. For example, the Other Product Component 355 could be another software system, such as e.g. an accounting system, a navigation system, an entertainment system, etc., which the TTS System Package 350P gets incorporated into. As another example, the Other Product Component 355 could be a hardware subcomponent, such as a cartridge, a USB dongle, a chip, a SIM card, a peripheral, etc., that will get physically hooked up with, installed or inserted etc. into the Hardware Device 375. As another example, the Other Product 355 could be the Hardware Device 375 itself, e.g. a robot, etc., that together with the incorporated voice Package 350P is then sold as a Composite Product 360 to the Consumer 500. As another example, the Other Product 355 could be a service, e.g. such as a smart television or movie subscription service, or e.g. such as a cloud computing service, etc., which is marketed and sold to the Consumer 500 as a Composite Product 360.

A first action step Procure TTS Package 200P results in the TTS System Package 350P being at hand. This action step 200P is the analogous action step in this embodiment of the Method 30 to the previously-discussed action step Procure TTS Product 200. Because the TTS System Package 350P is going to be used as a component in the Composite Product 360, it may not be required to turn it into a polished, consumer-facing product at this point. That can happen in the next action step.

A second action step Incorporate TTS System Into Other Product 700 takes the Other Product Component 355 and the TTS System Package 350P, and incorporates them together into a polished, consumer-facing Composite Product 360. For example, this could be on a licensed basis, with the TTS 350P being licensed out, or e.g. the Other Product 355 being licensed in, etc. As another example, it could be on a software library basis, with the incorporated Package 350P being a library with an API that is called by the Other Product 355. As another example, the incorporation could be on a product bundling basis, with the TTS System Package 350P being a utility or product that gets bundled together with one or more Other Product Components 355 and sold as a bundle 360. As another example, the incorporation could be on an embedding basis, with the TTS System Package 350P being embedded into the Other Product 355 and sold as a Composite Product 360. These are just some examples of how to Incorporate TTS System Into Other Product 700; how to do this will be straightforward to one skilled in the art.

A third action step Market & Purvey Composite Product 400P takes the Composite Product 360, and markets and purveys it as ancillary merchandise to the Customer 500, for installation on the Hardware Device 375. It is the analogous action to the first embodiment's Market & Purvey Product 400 action. For example, the Composite Product 360 may be designated as ancillary merchandise as a whole. As another example, the TTS system portion of the Composite Product 360 may be designated as ancillary merchandise, helping to purvey the Other Product 355.

### Connections and Interactions of the Second Embodiment—FIG. 2

The first action step is to Procure TTS Package 200P. This is done for the benefit of the Entity Wanting Promotion 100. Procure TTS Package 200P entails getting the TTS System Provider 600 to provide a TTS System Package 350P that is based on the Voice Recordings 250 of the Famous Person 150. The result of this step is the TTS System Package 350P.

The second action step Incorporate TTS System Into Other Product 700 is also done for the benefit of the Entity Wanting Promotion 100. It starts with the Other Product Component 355 and the TTS System Package 350P, taking these as components, and produces the Composite Product Incorporating TTS System Package 360 as a result.

The third action step is then to Market & Purvey The Composite Product 400P to the Customer 500, as ancillary merchandise referencing the Famous Person 150, for delivery to and installation into the Hardware Device 375. This step 400P uses the Composite Product 360 as the object of its Market & Purvey action. As before in the previous embodiment, the very act of Market & Purvey Composite Product 400P creates a de facto Marketing/Sales Promotion 450 in a particular Venue 475. However, usually the Market & Purvey Composite Product action 400P will be part of a larger Marketing/Sales Promotion 450, performed for the benefit of the Entity Wanting Promotion 100, to reach the Customer 500. And the Customer 500 interacts with the Hardware Device 375 to use the Device 375 and hear the voice of the Famous Person 150.

### Operation of the Second Embodiment—FIG. 2

As discussed, the second embodiment involves three action steps: first, Procure TTS Package 200P, resulting in the TTS System Package 350P. Second, Incorporate TTS System Into Other Product 700, using both the procured TTS System Package 350P and the Other Product Component 355, and resulting in the Composite Product 360. Third, Market & Purvey Composite Product 400P to the Customer 500 for use on the Hardware Device 375, stressing the auxiliary merchandise aspect of having the voice of the Famous Person 150 speaking through the TTS System Package 350P. Then the Customer 500 has opportunities to use the TTS System Package 350P portion of the Composite Product 360 on the Hardware Device 375.

As before, this Method generates Marketing and Promotion through two main aspects. First, because the Market & Purvey Composite Product 400P promotes the voice of the Famous Person 150 in the Composite Product 360 as a benefit for fans, the Customers 500, this enhances the overall Marketing/Sales Promotion 450 and acts to create more high-quality promotion by means of the promotion itself. Second, every time the Customer 500 uses the TTS System Package 350P aspect of the Composite Product 360 on the Hardware Device 375, on a familiar, ongoing basis for the long term, the Customer 500 gets to enjoy the voice of the Famous Person 150, which counts as promotion and a marketing impression. Thus the Method creates Marketing and Promotion through these two main aspects.

Because the TTS System Package 350P is going to be Incorporated 700 with the Other Product 355 into the Composite Product 360, in many cases it only needs to be polished to a professional OEM level. For example, it may not need front-end controls, nor an installation manual. On the other hand, as another example, if the Composite Product 360 is a bundle of different apps, each of which needs to be usable by itself, then a polished, user-facing stand-along product level of finish may be useful. In this case, either the TTS System Package 350P must have been developed to this level by the TTS System Provider 600 already, or the step of Incorporate TTS System Into Other Product 700 must provide this level of polish.

In the first embodiment shown in FIG. 1, marketing & selling the voice module as ancillary merchandise is relatively straightforward (for example, “Get Paris Hilton's talking TTS voice for your cell phone!” etc.). In the second embodiment shown in FIG. 2, there are more choices for promoting the Composite Product 360. As an example, the entire Composite Product 360 may be Marketed & Purveyed 400P as ancillary merchandise (e.g., “Get your Lady Gaga talking spaceship! It's out of this world!”, etc.). As another example, the Composite Product 360 may be Marketed & Purveyed 400P by mentioning the voice feature as an ancillary merchandise part of the product (e.g., “Get your robot backhoe, it talks with the TTS voice of Willie Nelson! Dig it!”, etc.). As another example, the Product 360 may be Marketed & Purveyed 400P by mentioning the TTS System Package 350P as ancillary merchandise coming with the Composite Product 360 (e.g., “Every Fireworks self-empowerment app comes bundled with a Katy Perry TTS voice for your phone! It's explosive!”).

In some alternative embodiments, the Other Product Component 355 may end up being a subcomponent of the Hardware Device 375, or may be the same as the Hardware Device 375. For example, some manufacturers may bundle a car as an Other Product Component 355 with a celebrity TTS System Package 350P, and then sell that talking car as a Composite Product 360. Then e.g. the car, or the car's computer, would be the Hardware Device 375.

### Alternative Embodiments—FIGS. 3-47

FIGS. 3-47 show partial views of alternative embodiments, specializing and replacing the Venue 475 with various alternate venues 475A-475SS. These alternative replacements may be made in any of the other embodiments. For example, an alternative replacement can be made for the Venue 475 in FIG. 1, marketing and purveying the TTS System Product 350, to come up with an alternative embodiment. Or, an alternative replacement can be made for the Venue 475 in FIG. 2, marketing and purveying the Composite Product 360, to come up with another alternative embodiment. Or, this replacement may be permuted and combined with one or more of the Alternative Embodiment section replacements discussed in following sections, e.g. one selected from FIGS. 48-54, etc. Note also that the one or more venues are not mutually exclusive, and an entity can generally market & purvey through more than one venue simultaneously.

FIG. 3 shows an Amusement Park 475A. The Market & Purvey step 400 or step 400P may be performed at the venue of an Amusement Park 475A. For example, if the amusement park has a favorite celebrity performer, this celebrity could be selected for the Famous Person 150; or for example guest performers could bring their own products; or the park could simply market & purvey a standard line of the most popular celebrities, etc.

FIG. 4. shows a Blog Post 475B. For example, this could be a WordPress, or a written blog, or a video blog, or a podcast, or an Internet radio station, etc. E.g. the Famous Person may be the blog's owner.

FIG. 5. shows a Booth 475C. For example, this could be a concert booth; a fair booth; a school, airport, trade-show, or shopping-center booth; etc. Very little real estate is required. A single sales person can hand out fliers detailing the marketing messages and instructions on how to obtain the product.

FIG. 6. shows an In-Program Messaging venue 475D. For example, this could be an advertisement in an app; an in-app upgrade purchase; an Ajax-driven client-server channel; a custom-program marketing channel for a smart TV or PC; a Facebook game in-app purchase; etc.

FIG. 7. shows a Conference 475E. For example, this could be a science conference such as SIGGRAPH; a sales conference; a business, telecommunications, or entertainment conference; and so forth.

FIG. 8. shows a Concert 475F. For example, this could be a rock concert; an acoustic concert; a voice, instrumental, or classical concert; etc. Concerts can also use Jumbotrons 475P and Booths 475C etc.

FIG. 9. shows a Concession Stand 475G. For example, this could be a concession stand at a stadium, a conference center, a concert hall, a museum, a technology center, etc.

FIG. 10. shows a Contest 475H. For example: a singing contest; a music contest; a reality-show contest; a video-game or computer-game contest; an entrepreneur contest; etc.

FIG. 11. shows a Convention 475I. For example, Comic-Con; a comics convention; an animation convention; a gaming convention; a computer gaming convention; an entertainment convention; etc.

FIG. 12. shows a Entertainment Event 475J.

FIG. 13. shows a Facebook Post 475K. Facebook posts can let fans know about the ancillary TTS.

FIG. 14 shows and Internet Venue 475L. This has to do with any marketing message or purveying message that is delivered over the Internet. Some examples of these include web pages, E-bay, banner ads, video feeds, javascript apps, Flash animation, 3D scenes, 3D animation, Second Life and similar, World of Warcraft and similar, other Massive Multiplayer Online Games, presentations based on Internet-passed verification tokens, etc.

FIG. 15. shows a Fundraising/Charity Event 475M. For example: a public television fundraising event; a charity fundraising event; a political fundraising event; a charity contest; a charity drive, such as a blood drive or a jobs drive; a school fundraising event; a startup fundraising event; a corporate fundraising event; etc. Sometimes these will be sponsored by a star who is the Famous Person 150.

FIG. 16. shows a Gossip Magazine 475N. For example, this could be an advertisement in the magazine, or it could be a column, an article, a special feature, or the cover, etc. For more examples, the magazine could be People, The National Enquirer, Star, Life & Style, m, OK, In Touch, Globe, or US Weekly, etc.

FIG. 17. shows a Gossip Television Show 475O. For example, Entertainment Tonight; The Tonight Show; The Insider; any of several Late Night shows; Access Hollywood; TMZ; SNL; Extra; etc.

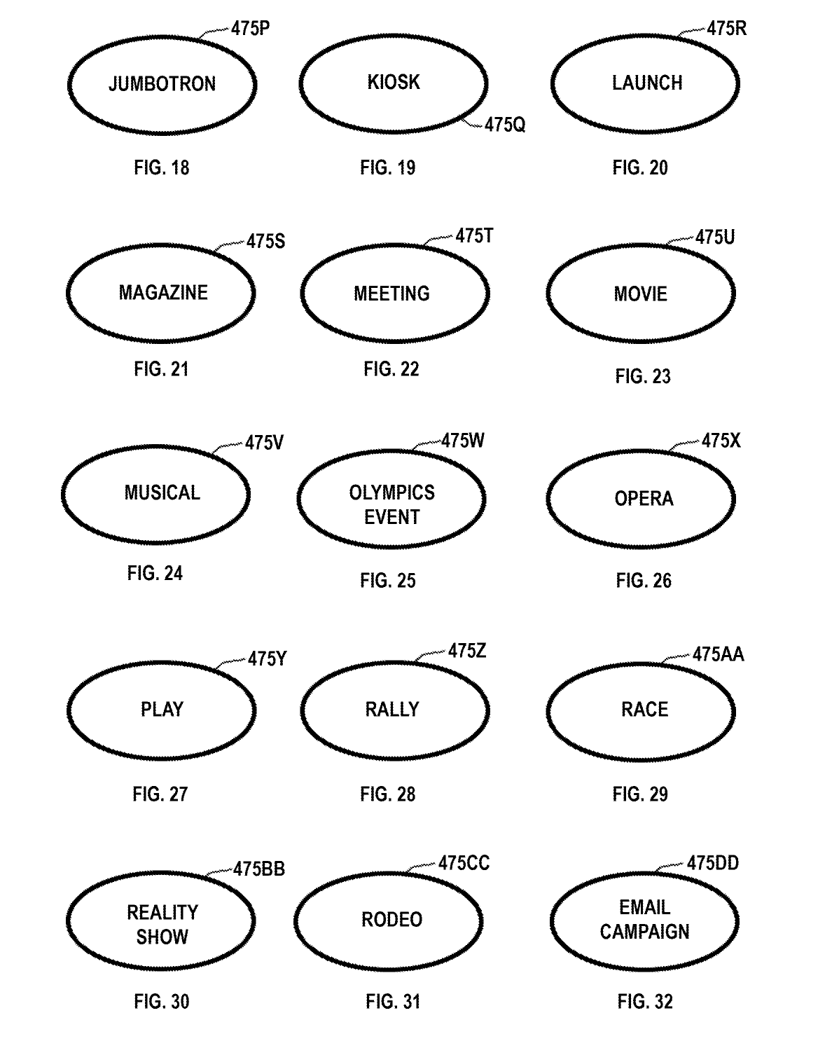

FIG. 18. shows a Jumbotron 475P. For example: a jumbotron at a concert; a jumbotron at a sports event; a jumbotron at a downtown large building; a jumbotron at a college/university; etc. The Jumbotron can show marketing & promotion of the product or composite product, then display a purveying website or mobile store address where customers can obtain the respective product, usually by download. This can allow customers to get the product immediately, in their seats, without having to wait in line. It can be a very efficient method of marketing & purveying.

FIG. 19. shows a Kiosk 475Q. A small kiosk can be a cost-effective way to sell ancillary merchandise for entrepreneurs without much startup money. Kiosks can operate e.g. at concerts, shopping centers, conference centers, trade shows, etc. Some kiosks already sell rubber phone cases and other accessories; expanding the line to ancillary TTS voice products could be profitable for them.

FIG. 20. shows a Launch 475R. For example: a product launch; a movie launch; an actor launch; etc.

FIG. 21. shows a Magazine 475S. For example: AARP, Game Informer, Better Homes & Gardens, Good Housekeeping, Reader's Digest, Family Circle, National Geographic, Woman's Day, Time, etc. Magazines can provide valuable marketing when PR human-interest articles about the auxiliary TTS are placed in them. For the cost of a PR agent, the equivalent of a full-page ad can be had for very little.

FIG. 22. shows a Meeting 475T. For example: a religious meeting, a political meeting, a club meeting, a business meeting, etc.

FIG. 23. shows a Movie 475U. For example: at a movie theater; at a new movie launch effort; promoted before the movie as pre-screen commercials; promoted inside the movie as product placement; sold at the movie souvenir store; with commercials bundled as part of the online delivery of a movie; etc. Movies are one major channel that can profit from ancillary TTS products. Often the Famous Person 150 may be someone who is going to be in an upcoming movie.

FIG. 24. shows a Musical 475V. For instance: at the musical; on the webpage of the musical's ancillary merchandise store; etc. One or more Famous People 150 can be the stars of the musical, allowing the marketing & purveying of potentially multiple TTS System products.

FIG. 25. shows a Olympics Event 475W. For instance: in person, or broadcast over a network, etc.

FIG. 26. shows a Opera 475X. Like the Musical 475V, this can be e.g. in person at the opera; on the webpage of the opera's ancillary merchandise store; through affiliate stores; etc. The Famous Person 150 will often be the star of the opera.

FIG. 27. shows a Play 475Y. See Opera and Musical.

FIG. 28. shows a Rally 475Z. For example, this could be an activist rally, a peace rally, a political rally, a protest rally, a cause rally, a pep rally, or a car rally, etc.

FIG. 29. shows a Race 475AA. For example, this could be a foot, car, yacht, horse, animal, bicycle, airplane, or motorcycle race; an Indianapolis 500, Le Mans, Grand National, Datona 500, or Grand Prix race; a drag race; a road rally race; a sprint; a marathon; a charity race; etc. For example, the Famous Person 150 could be a racer or someone associated with the race, etc.

FIG. 30. shows a Reality Show 475BB. For example, this could be an extraordinary people show; a dating show; a law enforcement/military show; a makeover show; a celebrity show; a fantasies show; a singing or dancing contest, etc.; a surprises show; an entrepreneur show; etc.

FIG. 31. shows a Rodeo 475CC. For example, this could be a cow, horse, deer, or animal rodeo, etc.

FIG. 32. shows an Email Campaign 475DD. Sending emails to prospects can be a useful and cheap way to market & purvey an ancillary TTS.

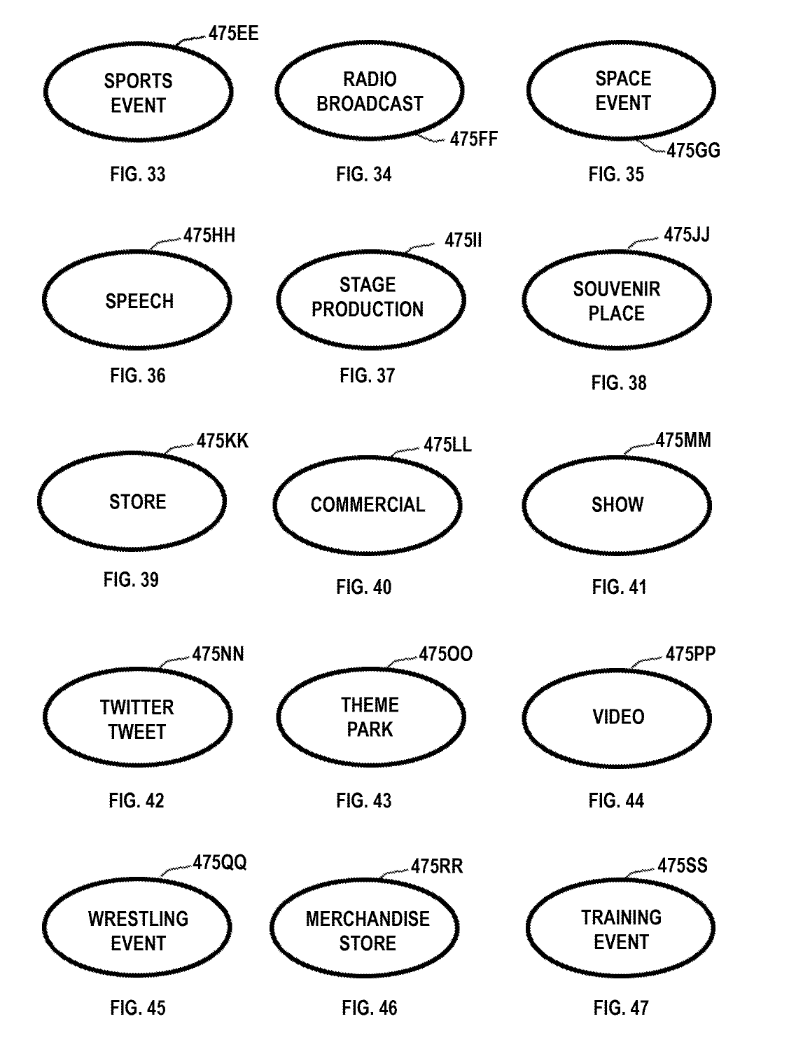

FIG. 33. shows a Sports Event 475EE. For example, this could be a soccer event, a cricket event, a basketball event, a hockey event, a field-hockey event, a tennis event, a volleyball event, a ping-pong/table tennis event, a baseball event, a football event, a rugby event, a golf event, a polo event, a cheerleading event, a horse show event, a skiing event, an extreme sports event, a boxing event, etc.

FIG. 34. shows a Radio Broadcast 475FF. This has the advantage that the voice and sound quality of the ancillary TTS of the Famous Person 150 can be demonstrated over the airwaves. It has the disadvantage that, if purveying is done using a URL, it's harder to read URLs over the radio as there is nowhere to click on them, and listeners who are driving often do not write them down. Examples include: radio programs; interviews on the radio; radio commercials; Internet radio; podcasts; etc.

FIG. 35. shows a Space Event 475GG. For example: a space launch; a space terminal open house; a space shuttle publicity event; a space station event; a planet, moon, or asteroid exploration event; etc.

FIG. 36. shows a Speech 475HH. For example: a political speech, a “motivational” speech, etc.

FIG. 37. shows a Stage Production 475II. For example, a Burning Man event; a Survival Research Labs event; a performance art event; a magic show; a hypnotism show; a big cats taming show; etc.

FIG. 38. shows a Souvenir Place 475JJ. For example: a souvenir store; a shopping-mall souvenir store; a street merchant stand that sells souvenirs; a famous location souvenir place; etc.

FIG. 39. shows a Store 475KK. For example: a physical store; an on-line store; a smart-phone store; a smart television store; a mail-order store; a Yahoo store; an E-Bay store; etc.

FIG. 40. shows a Commercial 475LL. For example: a television or radio commercial; a podcast commercial; a viral video; a banner ad; a smart-phone commercial; an Internet commercial; etc.

FIG. 41. shows a Show 475MM. For example, the Oprah Show; a television show; a radio show; a stage show; a performance art show; etc.

FIG. 42. shows a Twitter Tweet 475NN. Twitter can be an effective venue for marketing & purveying. The Famous Person 150 can announce the ancillary TTS to their followers. Examples of how to put together a Twitter campaign are apparent to one skilled in the art.

FIG. 43. shows a Theme Park 475OO. The Famous Person 150 will often be one of the characters in a movie owned by the Theme Park company. Often, more than one TTS product will be offered, representing a range of Famous People 150. The Theme Park may market & purvey the product e.g. physically on site, or virtually, at the Theme Park's web presence. The Theme Park may often use one or more of the other venue strategies, for example such as a Jumbotron 475P, Kiosk 475Q, Concession Stand 475G, Souvenir Place 475JJ, or Movie 475U, to market & purvey its ancillary TTS products. Marketing & Purveying a TTS Product 350 or a Composite Product 360 can result in a profitable marketing campaign that can also provide many impressions for years to come.

FIG. 44. shows a Video 475PP. For example, this can be a viral video; a comedy video; a video commercial; a video blog; a video on a mobile screen or appliance; a Jumbotron video; etc.

FIG. 45. shows a Wrestling Event 475QQ. For example: a physical wresting event; an event broadcast or rebroadcast on TV; a wrestling interview; etc. The Famous Person 150 can be e.g. a wrestling star.

FIG. 46. shows a Merchandise Store 475RR. For example, this could be an online merchandise store; a mobile device merchandise store; a physical merchandise store; a booth; a kiosk; etc.

FIG. 47. shows a Training Event 475SS. For example, this could be a motivation training event, such as Tony Robbins events; a sales training event; a business training event; a career training event; a weight-loss training event; a financial training event; etc.

### Alternative Embodiments—FIGS. 48-54

FIGS. 48-54 show partial views of alternative embodiments, specializing and replacing the Hardware Device 375 with various alternate hardware devices 375A-375G. These alternative replacements may be made in any of the other embodiments.

FIG. 48 shows a Computing Device 375A. Some examples of these include computers, smart phones, Apple brand computing machines, iPhones, Android OS devices, smart wristwatches, smart televisions, laptop computers, desktop computers, tablet computers, entertainment computer systems, gaming consoles, X-box machines, PlayStation machines, Amazon brand computing machines, book readers, business computers, devices containing a computer, computers that are built into other hardware, etc.

FIG. 49 shows a Vehicle 375B. Some examples of these include automobiles, airplanes, helicopters, trains, buses, trucks, land surface vehicles, water surface vehicles, air vehicles, space vehicles, underwater vehicles, vehicles that are also heavy equipment such as bulldozers or tanks, hover or glide vehicles, motorcycles, powered bicycles, etc. Usually there will be some kind of computing device inside the vehicle to run the TTS system, unless the TTS system is implemented as a hardware module.

FIG. 50 shows a Station 375C. Some examples of these include: bus stations, train stations, subway stations, fire stations, police stations, smart homes, smart factories, smart hospitals, smart office buildings, smart ports, smart traffic control centers, computerized buildings, and space stations, etc.

FIG. 51 shows an Unmanned Vehicle 375D. Some examples of these include drones, quadcopters, torpedoes, robot speedboats, satellites, and unmanned versions of any of the vehicles previously mentioned. The output speaker for the TTS system may appear inside the vehicle itself, on its outside, or on the vehicle's control module.

FIG. 52 shows an Appliance 375E. Some examples of these include talking microwave ovens, custom kitchens, refrigerators, coffeemakers, washing machines, toasters, juicemakers, lathes, bandsaws, etc.

FIG. 53 shows a Cloud 375F. Some examples of these include cloud computing service, servers, remote servers, streaming video networks, remote reporting systems, military systems, streaming computer game networks, smart cable service, distributed computing service, grid computing service, smart office managers, etc.

FIG. 54 shows a Robotic Device 375G. Some examples of these include personal robots, home robots, factory robots, entertainment robots, military robotic devices, construction robots, vehicle robots, etc.

### Alternative Embodiment—FIG. 55

FIG. 3 shows a partial view of an alternative embodiment. In this embodiment, the Entity Wanting Promotion 100 is replaced in the method with one or more Group(s) Wanting Promotion 100A. This alternative replacement may be made in any of the other embodiments.

The Group Wanting Promotion 100A is a group of entities that want the overall Marketing and Promotion effort to succeed.

It is not required, but not ruled out, that the entities composing the Group 100A be joined as a legal partnership, joint venture, or some other structure. In some cases, the Group 100A will be a loose group of interests getting together for Marketing and Promoting.

As some examples, the Group Wanting Promotion 100A may be composed of two or more record label companies; or a record label company and one or more musical groups; or a studio company and a marketing company; or a singer and a charity foundation; or a group of producers; or a manufacturing company and a celebrity; or a billionaire backer, a fundraising committee, and a politician; or a marketing company, a production company, and the Famous Person 150; or a venture capitalist team, an ancillary merchandise team, a software team, and a concert tour group; or a theme park company and a voice actor; or a recording producer, the TTS System Provider 600, the Productization Provider 650, and the Famous Person 150; or any combination of the single entities mentioned previously, etc. These are just some examples.

The Group Wanting Promotion 100A may be homogeneous, but will often be heterogeneous.

The Group Wanting Promotion 100A uses the same connections and interactions as the Entity Wanting Promotion 100, except of course these are done for members or the whole of the Group 100A instead of the Entity 100. For instance, the Procure TTS Product 200 action step illustrated in FIG. 1 is then done on behalf of one or more members of the Group 100A. As an example, if the Group 100A is composed of a recording label, a production company being the TTS System Provider 600, and a singer being the Famous Person 150, then the Procure TTS Product 200 action step could be performed by the production company on behalf of the Group 100A as a whole. Similarly, the Market & Purvey Product 400 action step will be performed on behalf of the Group 100A, or one or more of its members, and the Marketing/Sales Promotion 450 will be performed on behalf of the Group 100A, or one or more of its members.

Operation of the Method for this Alternative Embodiment proceeds in an analogous way.

Because Marketing and Promoting can be a complex effort, performing this Method on behalf of a Group Wanting Promotion 100A can provide a realistic and profitable way to obtain Marketing and Promoting. These again are obtained through two aspects: promoting for the sake of promoting ancillary merchandise; and, resulting in a satisfied Customer 500 who gets to enjoy close, personal marketing impressions in the form of listening to the voice of the Famous Person 150 on a familiar, ongoing basis for years.

### Alternative Embodiments—FIGS. 56-57

In the alternative embodiment partially illustrated in FIG. 56, based on FIG. 1, an Intermediate Customer 505 is introduced in the purveying distribution chain between the action of Market & Purvey Product 400 and the final end Customer 500. The Intermediate Customer 505 acts as a middleman. For example, the Intermediate Customer 505 may be a third-party distributor, or a third-party retailer. Then, in this case, the Intermediate Customer 505 becomes the direct object of the purveying step 400, for example in a wholesale relationship, and the Customer 500 becomes the indirect object. It is then up to the Intermediate Customer 505 to somehow get the Product 350 to the Consumer 500.

The alternative embodiment partially illustrated in FIG. 57, based on FIG. 2, shows the same introduction of the Intermediate Customer 505 in the case of a Composite Product 360.

### Alternative Embodiments—FIGS. 58-65

FIGS. 58-65 show partial views of alternative embodiments, specializing and replacing the Market & Purvey Product 400 action step with various alternate action steps 400A-400G. These alternative replacements may be potentially combined, and may be made in any of the other embodiments.

FIG. 58 shows a Market & Sell Product 400A action step replacing step 400. The Product 350 is sold to the Customer 500 as part of the purveying. This is one good alternative embodiment, as it offers the possibility of profit. Selling usually includes delivery, which for example may be done in the case of some embodiments by posting the TTS System Product 350 on the Google Play store or on the Apple iPhone store, etc. Then as the Customer 500 is sold the Product 350, said product is also downloaded and delivered at the same time.

FIG. 59 shows a Market & Distribute Product 400B action step. The Product 350 is distributed to the Customer 500. As one example, this can make sense when this alternative is combined with FIG. 56, using an Intermediate Customer 505 for distribution, etc.

FIG. 60 shows a Market & Give Away Product 400C action step. The Product 350 is given away to the Customer 500. Marketing And Promotion requires flexibility. In some cases, the Marketing and Promotion will benefit strategically more from Giving Away Product 400C than it might from Selling 400A. Normally, giving away a Product 350 for free will result in more Customers 500 taking advantage of the Product 350. This should end up yielding more marketing impressions. However, this has to be balanced against the loss in potential revenue from not Selling 400A the Product 350. There are also secondary considerations as Customers 500 can often lose respect for goods or services that are given away for free. Finally, giving a product away for free tends to destroy the market for this product in the future, so a version 2 release the following year would not earn any serious profits.

FIG. 61 shows a Market & Embed Product 400D action step. The TTS System Product 350 is embedded in the Hardware Device 375. For example, this can be done with a TTS System Product 350 that is a cartridge, or a chip, etc. As another example, when the hardware device is e.g. a Station 375C or a Vehicle 375B, and for example in the case that the Customer 500 is a business or institution, the TTS System Product 350 may need to be embedded in the hardware device in order to be used.

FIG. 62 shows a Market & License Product 400E action step. The Product 350 is licensed to be run in the Hardware Device 375. For example, sometimes it will be desirable to simply license the TTS Product 350 or Composite Product 360 to the Customer 500, instead of selling it outright to them. As another example, licensing can be done when the Customer 500 is a business or institution that will be using the TTS System Package 350P in a professional mode, etc. For instance, the Customer 500 could be a hospital, a government organization, a business, or an airport company that licenses the voice. In cases where this embodiment is combined with the permutation shown in FIG. 56, the product may be licensed to an Intermediate Customer 505 that then has means of purveying the product to the end-user Customer 500. For instance, the Intermediate Customer 505 may be a telephone carrier that is licensing the TTS system as a service product to provide to customers, etc.

FIG. 63 shows a Market & Bundle Product 400F action step. The Product 350 is bundled into or bundled with the Hardware Device 375.

FIG. 64 shows a Market & Rent/Lease Product 400G action step. The Product 350 is rented/leased for running in the Hardware Device 375.

FIG. 65 shows a Market & Offer Subscription To Product 400H action step. The Product 350 is offered as a subscription and runs on the Hardware Device 375. This also counts products that are in fact services. This approach is popular with telephone carrier companies and cable TV companies.

These are just some of the possible alternative embodiments. They may be combined, for instance, licensed AND rented/leased. Other alternatives are obvious to one skilled in the art.

### Alternative Embodiments—FIGS. 66-73

FIGS. 66-73 show partial views of alternative embodiments that are specialization action steps analogous to FIGS. 58-65, except they specialize and replace Market & Purvey Composite Product 400P in FIG. 2 instead of Market & Purvey Product 400 in FIG. 1. In other words, they deal with marketing and purveying the Composite Product 360. The action verbs have been explained in the previous section for respective FIGS. 58-65.

In some embodiments, the embedding part of Marketing & Embedding the Composite Product 400T is also done at the same time as Incorporate TTS System Into Other Product 700, by embedding the TTS System Package 350P into the Other Product Component 355, in cases when the Other Product Component 355 is also the Hardware Device 375 that the TTS System Package 350P runs on, etc.

Similarly, in some embodiments, the bundling part of Marketing & Bundle the Composite Product 400V is also done at the same time as Incorporate TTS System Into Other Product 700, by bundling the TTS System Package 350P with the Other Product Component 355, as a package offering, etc.

### CONCLUSION, RAMIFICATIONS, AND SCOPE

Here I have presented a method for marketing and promotion using a general Text-To-Speech (TTS) voice system as ancillary merchandise.

In the old days, the marketing of personal lifestyle possessions, such as the kind of car that a customer buys, was differentiated by color or industrial design, to make a fashion statement for the customer. As smart phones, computers, cars, appliances, robots, vehicles, and robotic devices get smarter and smarter, and start to speak in a general manner, it becomes important to differentiate the marketing of their models. Marketing a designer voice for the customer's smart phone, or marketing a robot, etc., with a famous personality's voice built in, supports both effective differentiation for the marketer, and enjoyment for the customer, in a win-win situation.

Marketing is typically a large cost center for big corporations. In 2014, an average Super Bowl commercial cost roughly one million dollars to create, and around four million dollars for a 30-second media placement slot. But embodiments of my method of using a TTS system as ancillary merchandise have a customer willingly paying for the privilege of potentially hearing a special voice, on an ongoing basis, for years into the future. This can turn the cost of marketing on its head, having the potential for turning this segment of a marketing campaign into a profit center.

Apple, Google, and Amazon are currently using generic voices that have been selected for the clarity of the voice itself, not because the voice actor is known for anything. Siri is only famous for being a TTS computer voice, it is primary merchandise. Hardly anyone can name the lady voice actor whom the Siri voice is based on. For more than thirty years, TTS systems have been constructed based on clarity. As a result, their marketing potential is weak, and their independent prices reflect this as well. In contrast, this method uses the power of ancillary TTS systems for marketing and promotion.

In the past, computer voices have only been selected based on the clarity of unknown voice actors. This method opens the field up for many celebrities, to help enable them to monetize their fame in a new way. Now, blog owners and Youtube channel operators will have something new to sell and help with marketing and promotion.

A key to successful ancillary merchandise is to make it be useful on an everyday basis. Mugs are useful. A pull-string talking doll is not. A general-purpose TTS voice system, which has the capacity to read books, read web pages, give driving directions, and more, is substantially more useful than any one special-purpose talking app that can do only one of these. And this means that it offers more attraction, and thus stronger marketing and promotion potential.

Apple, Google, and Amazon all have music, movie, and app departments in their online stores. In the future, they may very well have an additional department for famous TTS voices.

Marketing a TTS system product or bundle as ancillary merchandise opens up a much larger range of potential venues than are currently used to sell TTS systems. At present, a TTS system is mostly sold as part of a smart phone, so marketing is largely restricted to television commercials and events focusing on these electronics. However, when the entirety of the entertainment and sports industries are brought into play, suddenly it makes sense to market ancillary TTS systems anywhere there is already entertainment. Thus this method opens up powerful, new markets for TTS systems.

Generic TTS voices have been used to sell computers in the same generic way for over thirty years. Declaring a technological TTS system to be a lifestyle-choice chunk of ancillary merchandise transforms it into something valuable and more desired. This then allows the valuable TTS voice to be sold by itself, or to help sell other products, and possibly be part of an overall marketing & sales campaign. Thus, this value of the general TTS as ancillary merchandise supports a method for marketing and publicity.

1. A method for marketing and promotion comprising:
(a) providing at least one first customer,
(b) providing a famous personality known by said customer for being something other than a text-to-speech computer voice,
(c) providing voice recordings of said famous personality,
(d) providing a general text-to-speech system product based on said voice recordings,
(e) providing at least one hardware device of predetermined type available to said customer for usage, said hardware device having a means of running said general text-to-speech system product and having a means for sound output,
(f) providing at least one venue for marketing,
(g) procuring said general text-to-speech system product,
(h) marketing & purveying said text-to-speech product in or through said venue to said customer to run on said hardware device, said marketing & purveying using the attractive power of said famous personality to said customer,
whereby said text-to-speech system product is marketed & purveyed as ancillary merchandise to said customer for use on said hardware device, and said marketing & purveying as ancillary merchandise thereby creates or enhances an overall marketing/sales promotion, and said marketing & purveying as ancillary merchandise thereby allows said text-to-speech product to be marketed & purveyed in said venue thereby allowing novel venues and allowing an expanded range of selling, and the potential ongoing interaction of said customer using said text-to-speech system product on said hardware device and thus hearing the voice of said famous personality will thereby provide ongoing marketing and promotion, as well as may provide extra pleasure and enjoyment to said consumer above that of a generic-voiced text-to-speech system.

2. The method of claim 1 wherein said famous personality has an occupation selected from the group consisting of an activist, an actor, an astronaut, a banker, a celebrity, a chef, a comedian, a singer, a songwriter, a musician, an entertainer, a television commercial spokesperson, a disk jockey, a company owner, a millionaire, a rentier, an investor, a philanthropist, a religious leader, a psychology leader, a health leader, a doctor, a television personality, a talk show host, a reality star, an heir, a motivational speaker, a butler, a maid, a production assistant, a movie star, a real estate mogul, a consultant, a marketing consultant, a policeman, a soldier, a firefighter, a spokesperson, a cheerleader, a race car driver, a founder, an executive, a manager, an athlete, a referee, a team owner, a newscaster, a person who has become famous by appearing in a video, a youtube blogger, a fashion model, a photography model, a radio announcer, a blog owner, a deceased celebrity, and a specialist.

3. The method of claim 1 wherein said hardware device is selected from the group consisting of a computing device, a vehicle, a station, an unmanned vehicle, an appliance, a cloud, and a robotic device.

4. The method of claim 1 wherein said venue is selected from the group consisting of an amusement park, a blog post, a booth, an in-program messaging, a conference, a concert, a concession stand, a contest, a convention, an entertainment event, a facebook post, an internet, a fundraising/charity event, a gossip magazine, a gossip television show, a jumbotron, a kiosk, a launch, a magazine, a meeting, a movie, a musical, an olympics event, an opera, a play, a rally, a race, a reality show, a rodeo, an email campaign, a sports event, a radio broadcast, a space event, a speech, a stage production, a souvenir place, a store, a commercial, a show, a twitter tweet, a theme park, a video, a wrestling event, a merchandise store, and a training event.

5. The method of claim 1 wherein said marketing & purveying is selected from the group consisting of marketing & selling, marketing & distributing, marketing & giving away, marketing & embedding, marketing & licensing, marketing & bundling, marketing & renting/leasing, and marketing & offering a subscription.

6. The method of claim 1 further including an intermediate customer having a means of conveying said text-to-speech system product to said first customer, wherein said marketing & purveying takes as its direct object said intermediate customer and as its indirect object said first customer.

7. A method for marketing and promotion comprising:
(a) providing at least one first customer,
(b) providing a famous personality known by said customer for being something other than a text-to-speech computer voice,
(c) providing voice recordings of said famous personality,
(d) providing a general text-to-speech system package based on said voice recordings,
(e) providing at least one hardware device of predetermined type available to said customer for usage, said hardware device having a means of running said general text-to-speech system package and having a means for sound output,
(f) providing at least one venue for marketing,
(g) providing an other product component,
(h) providing a composite product based on incorporating said test-to-speech system with said other product component,
(i) procuring said general text-to-speech system,
(j) incorporating said text-to-speech system with said other product component to form said composite product,
(k) marketing & purveying said composite product in or through said venue to said customer to run on said hardware device, said marketing & purveying using the attractive power of said famous personality to said customer,
whereby said text-to-speech system incorporated with said other product component into said composite product is marketed & purveyed as ancillary merchandise to said customer for use on said hardware device, and said marketing & purveying as ancillary merchandise thereby creates or enhances an overall marketing/sales promotion, and said marketing & purveying as ancillary merchandise thereby allows said text-to-speech system incorporated with said other product component into said composite product to be marketed & purveyed in said venue thereby allowing novel venues and allowing an expanded range of selling, and the potential ongoing interaction of said customer using said text-to-speech system on said hardware device and thus hearing the voice of said famous personality will thereby provide ongoing marketing and promotion, as well as may provide extra pleasure and enjoyment to said consumer above that of a generic-voiced text-to-speech system.

8. The method of claim 7 wherein said famous personality has an occupation selected from the group consisting of an activist, an actor, an astronaut, a banker, a celebrity, a chef, a comedian, a singer, a songwriter, a musician, an entertainer, a television commercial spokesperson, a disk jockey, a company owner, a millionaire, a rentier, an investor, a philanthropist, a religious leader, a psychology leader, a health leader, a doctor, a television personality, a talk show host, a reality star, an heir, a motivational speaker, a butler, a maid, a production assistant, a movie star, a real estate mogul, a consultant, a marketing consultant, a policeman, a soldier, a firefighter, a spokesperson, a cheerleader, a race car driver, a founder, an executive, a manager, an athlete, a referee, a team owner, a newscaster, a person who has become famous by appearing in a video, a youtube blogger, a fashion model, a photography model, a radio announcer, a blog owner, a deceased celebrity, and a specialist.

9. The method of claim 7 wherein said hardware device is selected from the group consisting of a computing device, a vehicle, a station, an unmanned vehicle, an appliance, a cloud, and a robotic device.

10. The method of claim 7 wherein said venue is selected from the group consisting of an amusement park, a blog post, a booth, an in-program messaging, a conference, a concert, a concession stand, a contest, a convention, an entertainment event, a facebook post, an internet, a fundraising/charity event, a gossip magazine, a gossip television show, a jumbotron, a kiosk, a launch, a magazine, a meeting, a movie, a musical, an olympics event, an opera, a play, a rally, a race, a reality show, a rodeo, an email campaign, a sports event, a radio broadcast, a space event, a speech, a stage production, a souvenir place, a store, a commercial, a show, a twitter tweet, a theme park, a video, a wrestling event, a merchandise store, and a training event.

11. The method of claim 7 wherein said marketing & purveying is selected from the group consisting of marketing & selling, marketing & distributing, marketing & giving away, marketing & embedding, marketing & licensing, marketing & bundling, marketing & renting/leasing, and marketing & offering a subscription.

12. The method of claim 7 further including an intermediate customer having a means of conveying said composite product to said first customer, wherein said marketing & purveying takes as its direct object said intermediate customer and as its indirect object said first customer.
